(19) United States
(12) Patent Application Publication
(10) Pub. No.: US 2024/0218715 A1
(43) Pub. Date: Jul. 4, 2024

(54) IMPROVEMENTS TO LATCHES FOR MOVABLE BARRIERS OR THE LIKE

(71) Applicant: D & D Group Pty Ltd, Frenchs Forest, New South Wales (AU)

(72) Inventor: Scott Anthony Cosby, Narraweena, New South Wales (AU)

(21) Appl. No.: 18/558,258

(22) PCT Filed: May 5, 2022
(86) PCT No.: PCT/AU2022/050424

§ 371 Date: Oct. 31, 2023

(30) Foreign Application Priority Data
May 5, 2021 (AU) 2021901341

(51) Int. Cl. E05C 1/10; E05C 1/00; E05C 19/16; E05B 13/00

(52) U.S. Cl. CPC E05C 1/10; E05C 1/006; E05C 19/163; E05B 13/002

(57) ABSTRACT

Disclosed, in some embodiments, is a latch assembly mountable to a structure for securing a moveable barrier in a closed position. The latch assembly comprising a latching unit with a displaceable latch pin, and a retractable actuator mounted in a housing of the latching unit. The retractable actuator being moveable along a latch axis to move the latch pin towards a retracted position to enable the moveable barrier to be moveable from the closed position. The retractable actuator including an elongate body extending between opposing ends, and a knob being formed separate to the elongate body and mounted thereon via a mounting arrangement. Also disclosed, in some embodiments, is a receiver unit having a magnet for attracting the latch pin the latch pin towards a displaced position. The receiver unit including a receiver body and a carrier, the receiver body including an interior surface defining a cavity for receiving the carrier therein. The carrier being configured for retaining the magnet. The carrier includes at least one retention portion

### TECHNICAL FIELD

The present invention relates to a latch assembly mountable to a structure for securing a moveable barrier, and in some embodiments, a magnetic latch assembly.

### BACKGROUND ART

Known installations for magnetic latch assemblies are as a safety latch for a gate arranged so that young children cannot reach and operate the latch to pass through the gate. Swimming pools is a primary application. The latch assembly must be mounted out of reach so that a child is not able to reach the latch assembly to operate it to enter the pool area unsupervised. Similarly, playgrounds for young children may need a gate arranged in the opposite fashion so that a young child could not operate the latch to go out of the playground unsupervised.

The present assignees are the proprietors of Australian Patent No 2009281691 and equivalent U.S. Pat. No. 8,393,653 which disclose magnetic safety latches for swimming pool gates. An important characterising feature of these latches is that there is no mechanical inter-engagement and in particular no mechanical resistance required when the gate moves to its closed position, for example under the influence of spring hinges. Thus, the prospect of mechanical resistance of mechanical latches preventing the gate reaching the fully closed position and latching occurring is obviated.

On child safety applications, legislative requirements dictate that self-latching devices such as magnetic latches are often installed on the gate side that has potential danger, for example, magnetic latches are installed on the pool side so young children cannot reach and operate the latch to gain access to the pool. Shielding may also be implemented surrounding the latch to prevent children putting their hand through the gate to operate the latch through the gate slats from the underside of the latch. Whilst shielding is used on magnetic latches for playground gates, playground gates may not be subjected to annual inspection like swimming pool gate inspections. Furthermore, playground gates are often subjected to much higher abuse, such as impacts from footballs, which can damage or deform the shielding for the magnetic latches. If the shielding becomes damaged or deformed, they are often not reported for long periods, which can potentially put a young child's life in danger as young children may be able to reach and operate the latch and exit the playground.

It is to be understood that, if any prior art is referred to herein, such reference does not constitute an admission that the prior art forms a part of the common general knowledge in the art, in Australia or any other country.

### SUMMARY

According to an aspect, disclosed is a latch assembly mountable to a structure for securing a moveable barrier in a closed position, the latch assembly comprising a latching unit with a displaceable latch pin; and a retractable actuator mounted in a housing of the latching unit, the retractable actuator being moveable along a latch axis to move the latch pin towards a retracted position to enable the moveable barrier to be moveable from the closed position; the retractable actuator including an elongate body extending between opposing ends, and a knob being formed separate to the elongate body and mounted thereon via a mounting arrangement.

In some embodiments, the latch pin is formed separate to the retractable actuator, wherein the latching pin is coupled to the elongate body of the retractable actuator.

In some embodiments, the mounting arrangement allows the knob to rotate relative to the elongate body about the latch axis. In some embodiments, the knob rotates freely relative to the elongate body. Accordingly, the knob being formed separate to the elongate body, and being rotatable about the elongate body increases the difficulty of operation by young children. When the child stretches to reach the knob from the other side of the gate (either through the gate slats or by standing on the gate and reaching over), the freely rotating knob will prevent them from acquiring a firm grip on the knob to unlatch the latch assembly.

In some embodiments, the mounting arrangement between the elongate body and the knob restricts the amount of torque that can be applied from knob to the elongate body. The mounting arrangement between the elongate body and the knob may enable the knob to rotate on the elongate body when a threshold torque is applied to the knob. In other words, the elongate body and the knob may move together until the threshold torque is achieved, whereby the knob decouples from the elongate body and torque can no longer be applied to the elongate body. Prior to decoupling, the knob and elongate body can act as an integral unit, but once decoupled, the knob can freely rotate. At this point, the mounting arrangement may allow the knob to rotate relative to the elongate body about the latch axis. In this way, torque cannot be applied to the knob about a limited threshold which will transfer to the elongate body.

In some embodiments, the mounting arrangement captures the knob on the elongate body to prevent axial movement of the knob on the elongate body in the direction of the latch axis. The mounting arrangement may prevent removal of the knob from the elongate body in the direction of the latch axis.

In some embodiments, the latch assembly further comprises a retaining structure to prevent rotation of the elongate body about the latch axis relative to the housing of the latching unit.

In some embodiments, the housing of latching unit includes an internal wall defining a passage for receiving the elongate body of the actuator, and the retaining structure includes one or more complementary surfaces formed on the internal wall of the passage and an external surface of the elongate body to prevent rotation of the elongate body relative to the housing of the latching unit.

In some embodiments, one of the ends of the elongate body having an aperture for receiving the latch pin and said latch pin is movably secured with respect said end of the elongate body.

In some embodiments, a biasing means is provided between the latch pin and said of the elongate body, whereby the biasing means biases the latch pin towards the retracted position.

In some embodiments, the mounting arrangement comprise one or more complementary features formed on an internal wall of the knob and the external wall of the elongate body to allow rotation of the knob about the elongate body and prevent axial movement of the knob relative to the elongate body. The one or more complementary features may comprise at least one projection extending radially on the external wall of the elongate body, and a complementary recess formed on the internal wall of the knob. Alternatively, the one or more complementary features may comprise at least one projection extending radially on the internal wall of the knob, and a complementary recess formed on the external wall of the elongate body. The one or more complementary features of the mounting arrangement may be positioned toward one of the ends of the elongate body so as to align an end of the knob with the end of the elongate body extending from the housing of the latching unit.

In some embodiments, the knob is of a different colour to the elongate body.

In some embodiments, the mounting arrangement is releasable to allow removal and replacement of the knob on the elongate actuator.

In some embodiments, the knob forms part of a series of knobs with different characteristics each of which can be installed on the elongate actuator to adapt the characteristic of the latch assembly. Flexibility of the design of knobs and other components provides a design advantage.

In some embodiments, the latch assembly includes a receiver unit having a magnet for attracting the latch pin towards a displaced position. This may allow a moveable barrier to be secured in a closed position.

According to another aspect, disclosed is a safety barrier system for restricting access to an area, the safety barrier system comprising at least two structures; and at least one movable barrier, wherein one end of the at least one movable barrier is movably secured to one of the structures to allow the at least one movable barrier to move between two positions and the other end of the one movable barrier is operable with the other structure by the latch assembly such that the latch assembly secures the at least one moveable barrier in a closed position.

In some embodiments, the latching unit is secured to the at least one movable barrier and the receiver unit is secured to the other structure. Alternatively, the receiver unit is secured to the at least one movable barrier and the latching unit is secured to the other structure.

According to a further aspect, disclosed is a latch assembly mountable to a structure for securing a moveable barrier in a closed position, the latch assembly comprising a latching unit with a displaceable latch pin; and a retractable actuator mounted in a housing of the latching unit, the retractable actuator being moveable to move the latch pin towards a retracted position to enable the moveable barrier to be moveable from the closed position; the retractable actuator including an elongate body extending between opposing ends, and a knob being formed separate to the elongate body and mounted thereon via a mounting arrangement, wherein the elongate body and the knob are movable along on a latch axis to move the latch pin towards the retracted position, and the knob is rotatable about the latch axis.

In some embodiments, the elongate body and the knob are movable together along on a latch axis to move the latch pin towards the retracted position.

In some embodiments, the mounting arrangement allows the knob to freely rotate relative to the latch pin about the latch axis.

In some embodiments, the mounting arrangement allows the knob to freely rotate relative to the housing about the latch axis. Alternatively, the mounting arrangement allows the knob to freely rotate relative to both the latch pin and the housing about the latch axis.

In some embodiments, an end face of the elongate body in recessed into the knob. In some embodiments, a lock is housed in the elongate body.

In some embodiments, the latch pin is formed separate to the retractable actuator, wherein the latching pin is coupled to the elongate body of the retractable actuator.

According to a further aspect, disclosed is a latch assembly mountable to a structure for securing a moveable barrier in a closed position, the latch assembly comprising: a latching unit with a displaceable latch pin; and a receiver unit having a magnet for attracting the latch pin towards a displaced position and a carrier, the receiver unit including a receiver body including an interior surface defining a cavity for receiving the carrier therein, the carrier being configured for retaining the magnet; wherein, the carrier includes at least one retention portion for releasably retaining, i.e. holding the magnet in the carrier.

In some embodiments, the carrier includes at least one internal wall defining a magnet cavity for receiving at least a portion of the magnet. The at least one internal wall may have a latching face for spacing the magnet from the latch pin when the latch pin is in a displaced position. The at least one internal wall has a thickness which enables the latching face to space, i.e. separate, the magnet from the latching pin when the latch pin contacts the latching face in the displaced position.

In some embodiments, the at least one retention portion may be formed as at least one rib on the internal wall and may extend into the magnet cavity. The rib can extend a predetermined distance into the cavity such that when a magnet is placed between within the cavity, the rib applies a releasable retention force, i.e. an interference fit.

In some embodiments the at least one internal wall defining the magnet cavity includes two internal side walls, two end walls and a rear wall. The rear wall may be shaped to correspond to the shape of the magnet.

In some embodiments, the rear wall may be an arcuate shape to correspond to the shape of a cylindrically-shaped magnet. The arcuate shape of the rear wall may be semi-circular to match a corresponding semi-circular portion of the cylindrically shaped magnet.

In some embodiments, the at least one rib extends from an opening of the magnet cavity along each side wall to the rear wall.

In some embodiments, the retention portion may include a transition surface extending at an angle between the side wall and the at least one rib, i.e. a distal surface of the rib. The transition surface may be tapering towards the rear wall to allow the magnet to be inserted into the magnet cavity. The tapering transition surface may allow the magnet to be inserted by reducing the magnitude of the interference fit.

In some embodiments, the opening may be defined by an edge region of the side walls and the end walls defining the magnet cavity. The edge region of the side walls and end walls may be arcuate to be correspondingly shaped to the interior surface of the receiver body. The side walls and end walls may be arcuate in shape when viewed in profile, i.e. from the side walls.

In some embodiments, the receiver body and the carrier may be formed from different materials.

In some embodiments, the receiver body may be formed of a metallic material and the carrier may be formed from a polymeric material.

In some embodiments, the receiver body may include at least one carrier-mounting boss configured to releasably connect with at least one respective and correspondingly shaped protrusion of the carrier.

In some embodiments, the receiver body may include at least one structure-mounting boss configured to releasably connect the receiver body to the structure.

In some embodiments, the at least one carrier-mounting boss and the at least one structure-mounting boss may extend from the cavity towards an opening at a rear of the receiver body.

In some embodiments, the at least one carrier-mounting boss and the at least one respective and correspondingly shaped protrusion of the carrier may be arranged such that when the carrier is received in the cavity of the receiver body, the at least one structure-mounting boss may be accessible at the rear of the receiver body for mounting the receiver unit to the structure. The receiver body and carrier are therefore complimentary in shape such that carrier can be nested within the cavity without impeding access to the structure-mounting bosses. This allows the carrier to be contained within the receiver body, when the receiver unit is mounted to the structure, without the carrier being mounted to either the structure or the receiver body.

In some embodiments, the at least one structure-mounting boss may be configured to receive a threaded fastener for releasably mounting the receiver unit to the structure.

In some embodiments, the receiver unit may include a latching cavity for receiving the latch pin.

In some embodiments, the latching cavity may be obround-shaped for accommodating vertical misalignment between the latch pin and the latching cavity.

In some embodiments, the latching cavity may be obround-shaped to limit lateral movement between the latch pin and the latching cavity.

In some embodiments, the latching face of the at least one internal wall may be positioned with respect to the latching cavity such that the latching face generally separates the latching cavity from the cavity of the receiver body.

In some embodiments, the latching cavity may be a combination of an aperture provided in the receiver body and said aperture being closed off by the carrier.

In some embodiments, the latching face may be configured to contact the latch pin so as to limit the movement of the latch pin when in a displaced position. The position of the latching face with respect to the cavity can determine how far the latching pin displaces into the latching cavity when in the displaced position.

### BRIEF DESCRIPTION OF THE DRAWINGS

For illustrative purposes embodiments of the invention will now be described with reference to the accompanying drawings of which:

FIG. 1 is an isometric view of a prior art magnetic latch arranged in the latched configuration;

FIG. 2 is a front elevation of the magnetic latch of FIG. 1 in the latched and locked position;

FIG. 3 is a cross-sectional view along the line A-A of FIG. 2 and showing the latch in the latched and locked position;

FIG. 4 is a front elevation of the latch in the latched and unlocked position;

FIG. 5 is a cross-sectional view along the line B-B of FIG. 4.

FIG. 6 is a front elevation of the latch when pulled in the unlatched position.

FIG. 7 is a cross-sectional view along the line C-C of FIG. 6.

FIG. 8 is a front elevation of the latch in an unlatched, free and unlocked condition;

FIG. 9 is a cross-sectional view along the line D-D of FIG. 8;

FIG. 10 is a front elevation of the latch in an unlatched, free but locked condition;

FIG. 11 is a cross-sectional view along the line E-E of FIG. 10;

FIG. 12 is an isometric view of a first embodiment of a magnetic latch assembly according to the present disclosure arranged in the latched configuration;

FIG. 13 is a partial exploded view of the magnetic latch assembly of FIG. 12;

FIG. 14 is a front elevation of the magnetic latch assembly of FIG. 12 in the latched and locked position;

FIG. 15 is a cross-sectional view along the line A-A of FIG. 14 and showing the latch in the latched and locked position;

FIG. 16 is a front elevation of the magnetic latch assembly of FIG. 12 in the latched and unlocked position;

FIG. 17 is a cross-sectional view along the line B-B of FIG. 16;

FIG. 18 is a front elevation of the latch when pulled and in the unlatched position.

FIG. 19 is a cross-sectional view along the line C-C of FIG. 7.

FIG. 20 is a front elevation of the latch in an unlatched, free and unlocked condition;

FIG. 21 is a cross-sectional view along the line D-D of FIG. 9;

FIG. 22 is a front elevation of the latch in an unlatched, free but locked condition;

FIG. 23 is a cross-sectional view along the line E-E of FIG. 22;

FIG. 24 is a front elevation of a fencing system comprising a magnetic latch assembly in a latched configuration according to the present invention;

FIG. 25 is an isometric view of a second embodiment of a magnetic latch assembly of the present disclosure arranged in the latched configuration;

FIG. 26 is a partial exploded view of the magnetic latch assembly of FIG. 24;

FIG. 27 is a front elevation of the magnetic latch assembly of FIG. 25 in the latched and locked position;

FIG. 28 is a cross-sectional view along the line A-A of FIG. 27 and showing the latch in the latched and locked position;

FIG. 29 is a front elevation of the magnetic latch assembly of FIG. 25 in the latched and unlocked position;

FIG. 30 is a cross-sectional view along the line B-B of FIG. 29;

FIG. 31 is a front elevation of the latch when pulled and in the unlatched position.

FIG. 32 is a cross-sectional view along the line C-C of FIG. 31.

FIG. 33 is a front elevation of the latch in an unlatched, free and unlocked condition;

FIG. 34 is a cross-sectional view along the line D-D of FIG. 33;

FIG. 35 is a front elevation of the latch in an unlatched, free but locked condition;

FIG. 36 is a cross-sectional view along the line E-E of FIG. 35;

FIG. 37 is a side view of the prior art latching unit of FIG. 1;

FIG. 38 is a side view of the latching unit of FIGS. 12 and 25;

FIG. 39 is an exploded front isometric view of a further embodiment of a receiver unit according to the present disclosure;

FIG. 40 is an exploded rear perspective view of the receiver unit of FIG. 40;

FIG. 41 is the rear perspective view of the receiver unit of FIG. 41 when assembled;

FIG. 42 is an exploded front view of the receiver unit of FIG. 40; and

FIG. 43 is a cross section view through line F-F of FIG. 42.

### DETAILED DESCRIPTION OF THE EMBODIMENTS

In the following description, functionally similar parts carry the same reference numerals between different embodiments. The drawings are intended to be schematic, and dimensions, scale and/or angles may not be determined accurately from them unless otherwise stated.

It is understood that, unless otherwise stated, the upward and downward directions refer to the orientation of a latch when mounted onto a substantially vertical surface.

It is understood that, unless otherwise stated, the structure may include a moveable barrier, a gate, a fence, a panel, a post or any other suitable structure for mounting a latch assembly.

It is understood that, unless otherwise stated, the terms bracket, and fixture are intended to have their plain meaning.

It is understood that, unless otherwise stated, the term mount includes temporily secured, attached, removably fixed and secured, whereby the term is intended to describe one component placed onto another component or body and not limited to the type of fixture used or if the fixture is permanent or temporary.

It is understood that, unless otherwise stated, the term movable barrier includes, for example, a structure, hatch, gate, door, skylight or window, i.e. a member suitable for closing or opening an aperture, but not limited to the pivotal or direction of movement. For example, the member may pivot or slides horizontally and/or vertically.

It is understood that, unless otherwise stated, the terms aligned and/or alignment are not limited to concentric alignment, horizontal alignment, vertical alignment and planar alignment etc.

Although the following detailed description discloses the latch being mounted on a structure in the form of a post and a striker being mounted on a structure in the form of a gate, in alternative embodiments this may be reversed, i.e. the latch may be mounted on the gate and the striker may be mounted on the post.

We refer to Australian Patent No 2009281691 which is directed to a prior art magnetic latch assembly, which is incorporated herein by cross-reference in its entirety.

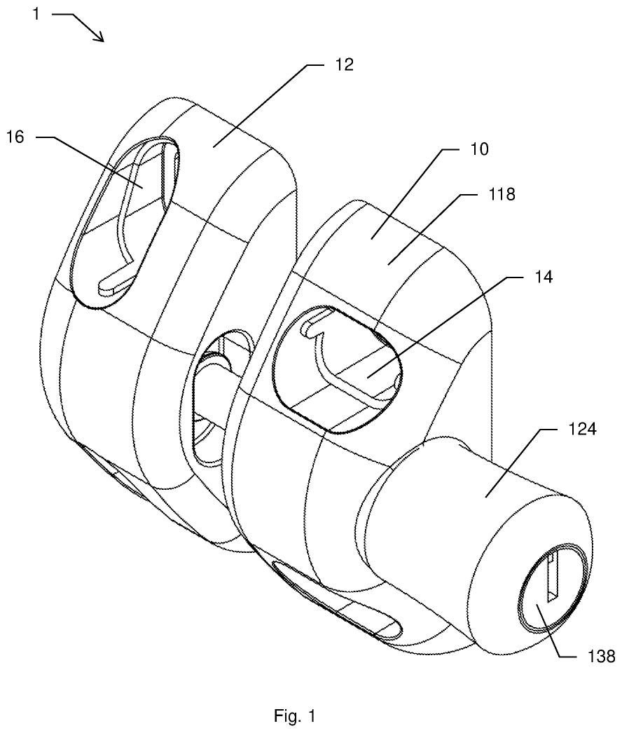

FIGS. 1 to 11 shows a prior art magnetic latch assembly 1 comprising a latching unit 10 and a receiver unit 12 adapted respectively to be mounted on a movable barrier, e.g. a gate, and a structure such as a gate post. The magnetic latch assembly 1 is mountable thereto with suitable fixing screws for securing the moveable barrier in a closed position.

FIG. 1 shows provision for fixing screws to pass through horizontally elongated slots 14 in the latching unit 10 and vertically elongated slots 16 in the receiver unit 12 whereby the latching unit 10 and receiver unit 12 respectively, before final tightening of the screws, can be adjusted for true alignment respectively horizontally and vertically. In use, press-in cover elements (not shown) will be provided for closing the apertures leading to the slots 14 and 16.

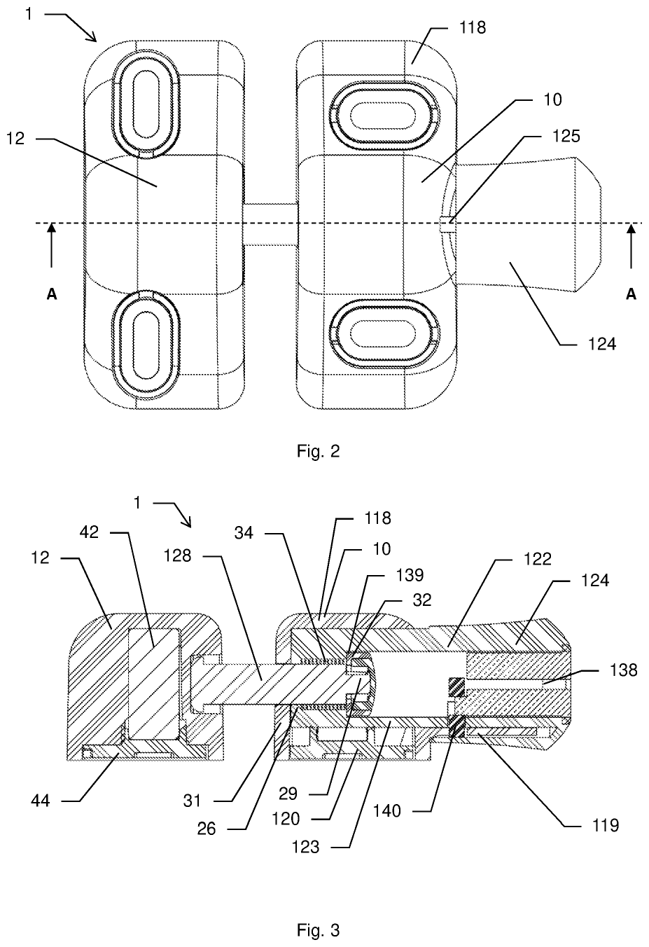

As shown in FIGS. 2 to 5, the latching unit 10 comprises a housing 118 with a base plate 120 and displaceably mounted therein, for movement along an axis of a latch pin 128, a retractable actuator 122 comprising a retraction knob 124. As shown in the Figures, the retractable actuator 122 includes an elongate body 123 in the form of a slideable barrel. The elongate body 123 has opposing ends and is supported at one end by a tubular extension 119 of the housing 118. The elongate body 123 is slidably fit to the tubular extension 119 which extends into an annular cavity defined between an outer wall of a cylindrical extension 123 and a knob 124. The knob 124, also referred to as a retraction knob, can be adapted to be manually gripped for displacement purposes.

The latching unit 10 comprises a retaining structure to prevent rotation of the elongate body 123 about the latch axis relative to the housing 118. The retaining structure includes a spline 125 integrally formed in the actuator 122 extending from a forward mid-position of an external surface of the elongate body 123, i.e. at a position towards the housing 118 and generally parallel with the latch axis. The housing 118 includes an internal wall defining a passage for receiving the elongate body 123 of the actuator 122, such that when the actuator 122 is received in the passage, the spline 125 engages a complementary slot in the housing 118. In this way, the retaining structure includes one or more complementary key surfaces, i.e. complimentary features, formed on the internal wall of the passage and an external surface of the elongate body 123 to prevent rotation of the actuator 122 while enabling axial movement of the retractable actuator 122 relative to the housing 118.

In the prior art magnetic latch assembly 1, the retractable actuator 122 and retraction knob 124 is a unitary component and at its forward end, i.e. an end towards the housing 118, there is provided a support barrel 26 in which the latch pin 128 is slidingly mounted for limited independent movement relative to the retractable actuator 122. Whilst the retractable actuator 122 and the retraction knob 124 can be moulded in a different colour to the housing 118 to provide a visual indicator, the complex geometry of the retractable actuator 122 and the retraction knob 124 make it difficult to achieve the consistent surface finish and strength with the other components, as moulding parameters can even differ between different coloured moulding granules of the same material.

Support for the latch pin 128 is provided at the support barrel 26 and also within an enlarged bore 30 of the retraction knob 124 in which a cap 32, fitted to the end of the latch pin 128, can slide. A biasing means in the form a helical compression spring 34 is provided between the latch pin 128 and the elongate body of the actuator 122, whereby the spring 34 can bias the latch pin 128 towards a retracted position, i.e. in the position shown in FIG. 9.

A helical compression spring 34 is mounted over a rear end portion of the latch pin 128, a forward end of the spring 34 being seated on a shoulder 36 defining an end of the support barrel 26 and a rear end of the spring being seated on a shoulder of the cap 32.

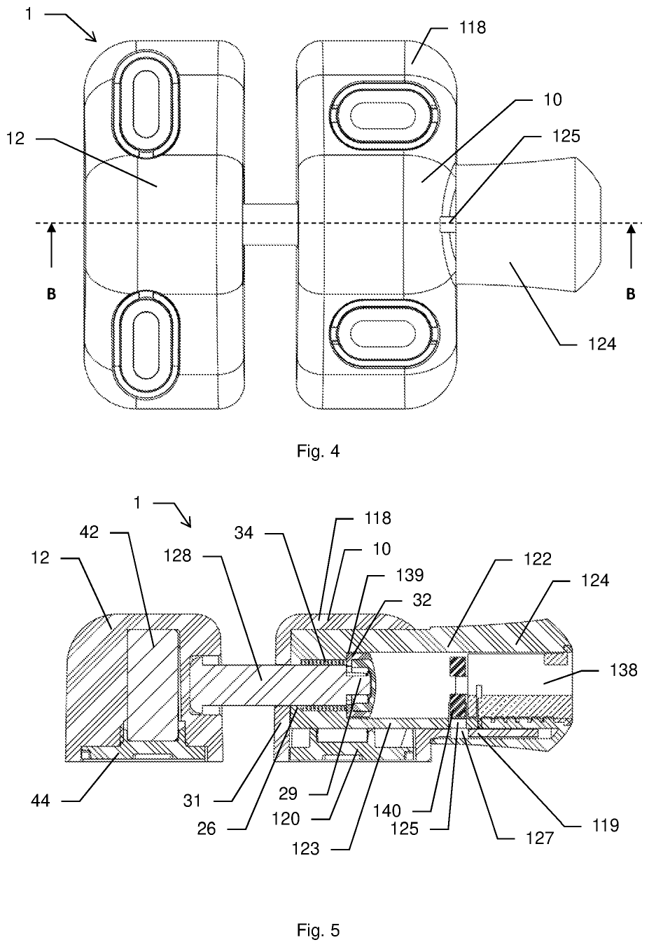

The latch pin 128 is magnetically attracted towards a high coercivity magnet 42 in the receiver unit 12. In practice, it can be envisaged the distance between the latch housing unit 10 and receiver unit 12 can be variable depending on the gap between the gate and the gate post. For example, when the latch assembly 1 is in a latched position (for example, as shown in FIGS. 4 and 5), and the gap between the gate and the gate post is at a maximum distance, i.e. maximum gap, a peripheral portion of the cap 32 engages against a shoulder 139 in an intermediate portion of the actuator 122 when the latch pin 28 engages with the receiver unit 12. In an alternative example, when the latch assembly is in a latched position with a reduced gap between the gate and gate post, the peripheral portion of the cap 32 is disengaged from the shoulder 139, but the latch pin 28 remains engaged with the receiver unit 12. With the reduced gate gap, the compression spring 34 would be substantially less compressed when compared with the maximum gate gap. This feature is known as a lost motion mechanism, whereby the latch pin 128 is free to float relative to the other components of the latching unit 10. The lost motion mechanism will be described in more detail later.

The retraction knob 124 substantially houses a key-operated lock 138, whereby the lock 138 is axially engaged within an end portion of the retraction knob 124. The lock 138 has a lock tongue 140 which, by comparing FIGS. 3 and 5, can be seen when the tongue 140 is moved from the unlocked position to the locked position.

FIGS. 2 and 3 show a configuration when the lock 138 is locked and the latch 10 is in the latched position. FIGS. 4 and 5 show a configuration when the lock 138 is unlocked and the latch 10 is in the latched position.

When the lock 138 is in the locked condition, its locking tongue 140 is moved laterally through an aperture 125 in the side wall of the cylindrical extension 123 and through an aperture 127 in the adjacent tubular extension 119 of the housing 118. Thus, in the locked position the pressure on the knob 124 to move the actuator 122 to a retracted position is resisted by a lock tongue 140. In the configuration shown in FIG. 3, the latch pin 128 (conveniently of a suitable grade of ferromagnetic steel or equivalent) is magnetically attracted into latching engagement of the receiver unit 12 and thus the associated gate cannot be opened.

The receiver unit 12 comprises a main body portion having a central cavity for accommodating the high coercivity permanent magnet 42 which is located in a weather-sealed cavity by engagement of a back plate 44. As can best be seen from FIG. 1, the housing 12 has an obround shaped latching cavity 46 which permits a degree of vertical misalignment between an enlarged tip/head 128A of the latch pin 128 and the latching cavity 46 (i.e. a receiving cavity 46), yet latching will still occur. For example, a gate or gate post may drop slightly and this can be accommodated with the design.

As shown in FIGS. 3 to 11, the cap 32 is fitted to a circular cross-section spigot portion 29 of the latch pin 128. The cap 32 has two parts: a base portion 32A fitted over the spigot 29 and a curved cap 32B. The base portion 32A is provided with an annular cavity for receiving a projecting lip of the curved cap 32B. The curved cap 32B fits into the annular cavity to complete the installation.

Regarding the configuration shown in FIG. 3, it will be appreciated that the latch pin 128 is free to float relative to the other components of the latching unit 10. Therefore, if for example due to thermal contraction at night the distance between the latch housing unit 10 and the receiver unit 12 increases, the magnetic attraction between the latch pin 28 and the magnet 42 can move the latch pin relative to the latch housing unit 10 and the actuator 122. The magnetic attraction maintains the head 128A of the latch pin 128 firmly engaged in the cavity 46 to maintain the latching engagement as shown in FIG. 3. This is one of the advantages of the lost motion mechanism.

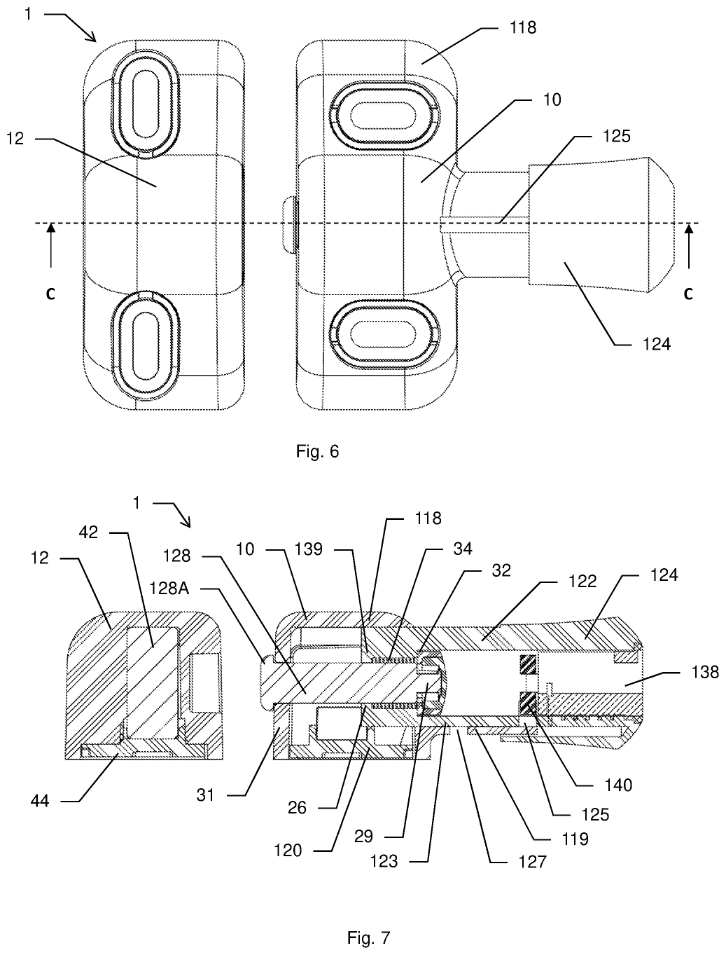

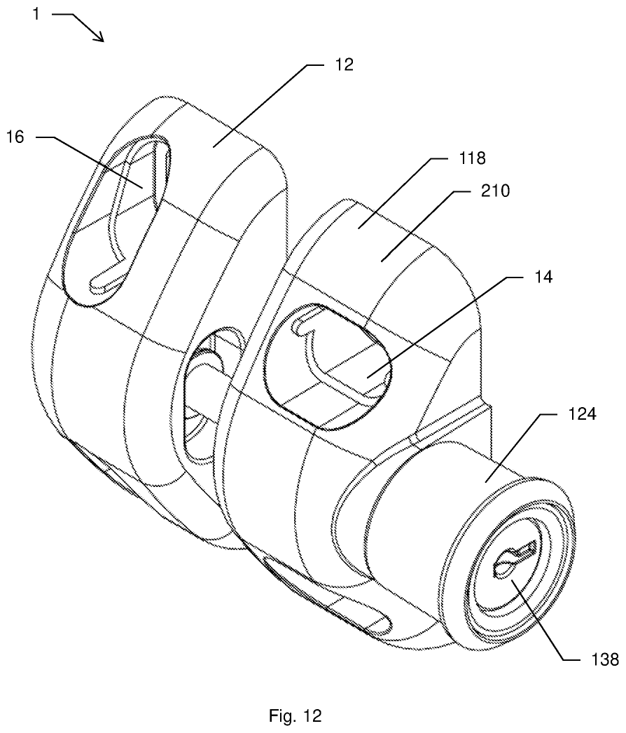

When the lock 138 is unlocked, the locking tongue 140 is displaced and the knob 124 can then be pulled to the right to the configuration shown in FIGS. 6 and 7. When compared to FIGS. 9 and 11, pulling of the retraction knob 124 causes the spring 34 to be compressed and the peripheral portion of the cap 32 engages against a shoulder 139 in the intermediate portion of the actuator 122. This allows the latch pin 128 to be retracted. Further pulling movement of the knob 124 is limited by the enlarged tip/head 128 of the latch pin 128 which abuts an end face 31 of the housing 118.

During retraction, and as mentioned above, the retractable actuator 122 is supported at one end by being slidingly fit with the tubular extension 119 of the housing 118 which extends into the annular cavity defined between the outer wall of the cylindrical extension 123 and the profiled knob 124. The opposing end of the retractable actuator 122 is supported by a combination of the latch pin 128 being supported by the support barrel 26 and the latch pin 128 being supported by an aperture 31a through the end face 31 of the housing 118. Therefore, it can be appreciated that the retractable actuator 122 and the latch pin 118 are slidingly supported with respect to the housing 118. In other words, the end 31 of the elongate body has an aperture for receiving the latch pin, whereby the latch pin is movably secured with respect to the end 31 of the elongate body.

It will be appreciated that, when in the position shown in FIG. 3, the initial movement of the actuator 122 to the right (i.e. towards the position shown in, e.g. FIGS. 6 and 7) initially increases the load on, and compression of, the helical spring 34 until the force applied to the latch pin 128 exceeds the magnetic attraction occurring between the latch pin 128 and the magnet 42 when in the position shown in FIG. 3. However, the shoulder 139 in the mid-portion of the actuator 122 will ultimately engage an interior surface of the cap 32 when the spring is completely compressed to displace the latch pin 128 towards the retracted position of the actuator shown in FIG. 7.

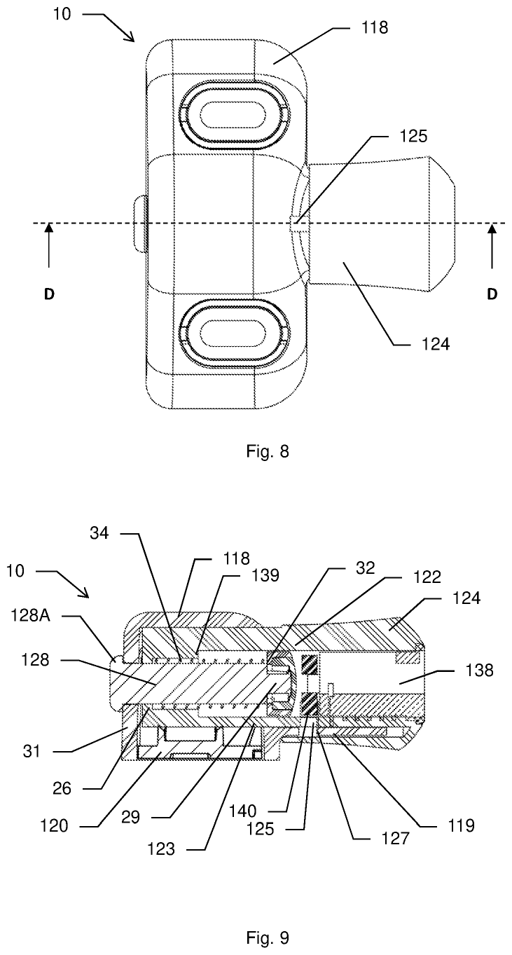

Referring to FIGS. 8 and 9, the latch assembly is shown in a position when a gate has been opened and the latching unit 10 is unlatched and remote from the receiver unit 12, the knob 124 released or retracted. As shown, the lock 138 is unlocked. With the knob 124 released, the latch pin 128 is also retracted. With the gate opened and unlatched, it can be appreciated the helical spring 34 is extended and urges both the latch pin 28 and the knob 124 to a fully retracted position as shown in FIG. 9. Therefore, if the gate is moved from an open position into a closed position e.g. by the action of self-closing spring-tensioned hinges, when the latching unit 10 is in juxtaposition with the receiver unit 12 for latching, the latch pin 128 is free to be attracted under magnetic influence to the configuration shown in FIG. 5. In this configuration, the compression spring 34 is compressed and thus magnetic latching will occur when the lock 138 is in the unlocked configuration.

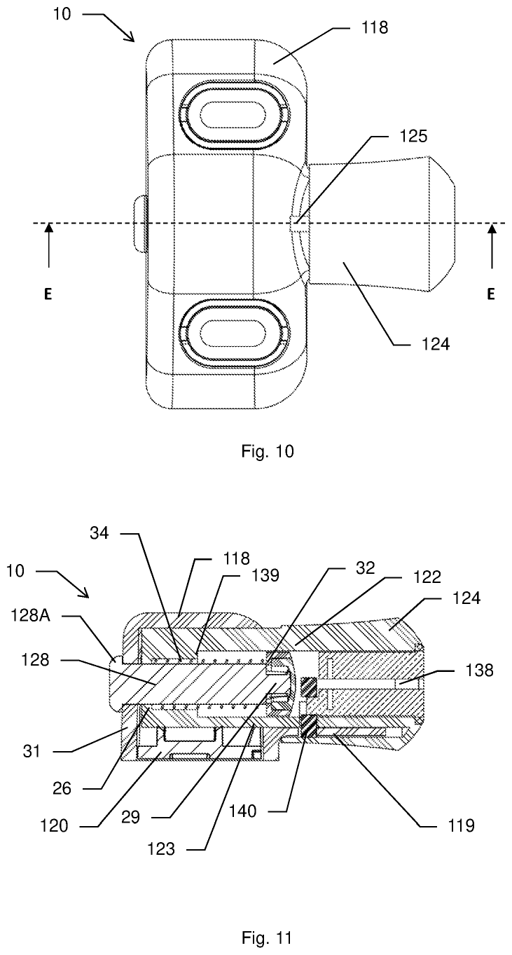

FIGS. 10 and 11, show the configuration when the latching 10 (and the gate) are in the open position and the lock 138 is locked, yet the latch pin 128 is free to move axially. Therefore, when the gate is released from an open position and moves to a closed position, i.e. a latching position, the latch pin 128 is free to move to the position shown in FIGS. 2 and 3 under the influence of the magnetic force to achieve latching. In this configuration, the latching unit 10 is locked but has safely achieved magnetic latching. This is another advantage of the lost motion mechanism.

In the event the user perversely seeks to lock the lock 138 when the latching unit 10 is in the configuration shown in FIGS. 6 and 7, the lock 138 cannot be locked as the lock tongue 140 abuts the tubular extension 119. In this case, when the actuator 122 is released it moves towards the position of FIGS. 4 and 5 whereby the end of the retractable actuator 122 (i.e. the end of the elongate body 123 opposing the knob 124) abuts an internal surface of the end face 31 of the housing 118. Thus, the actuator 122 can be retracted, as shown in FIG. 3, when the gate is moved into a closed position because the latch pin 128 is free to move under the influence of the magnetic force to achieve latching. In this configuration, the latching unit 10 is not locked but has achieved magnetic latching. This is another advantage of the lost motion mechanism, whereby the latch assembly can safely latch the gate to the gate post in a closed position, without the lock 138 being engaged in the locked position.

Locking of the knob 124 relative to the housing 118 can only be achieved when apertures 125 and 127 are aligned as shown in FIGS. 3, 5, 9 and 11.

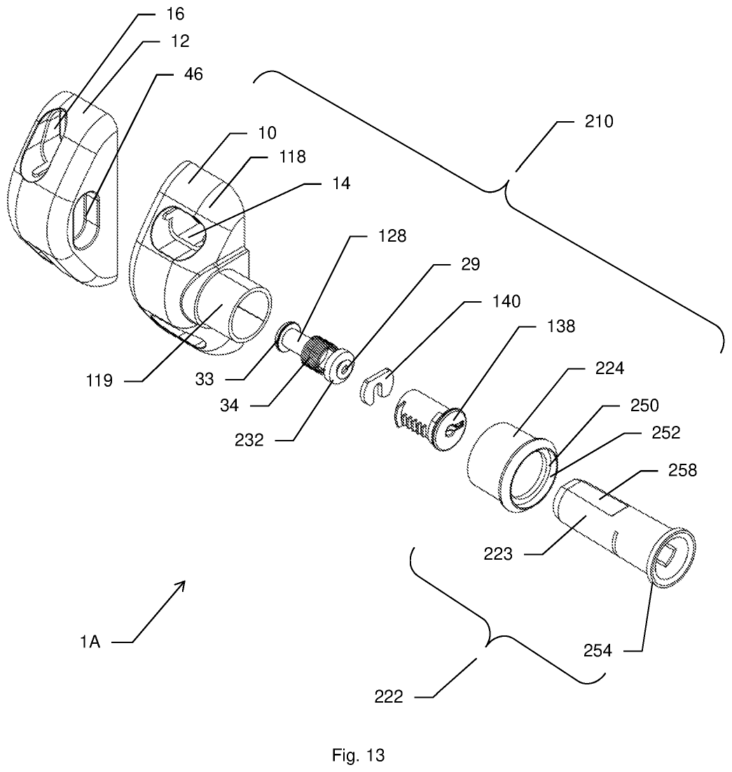

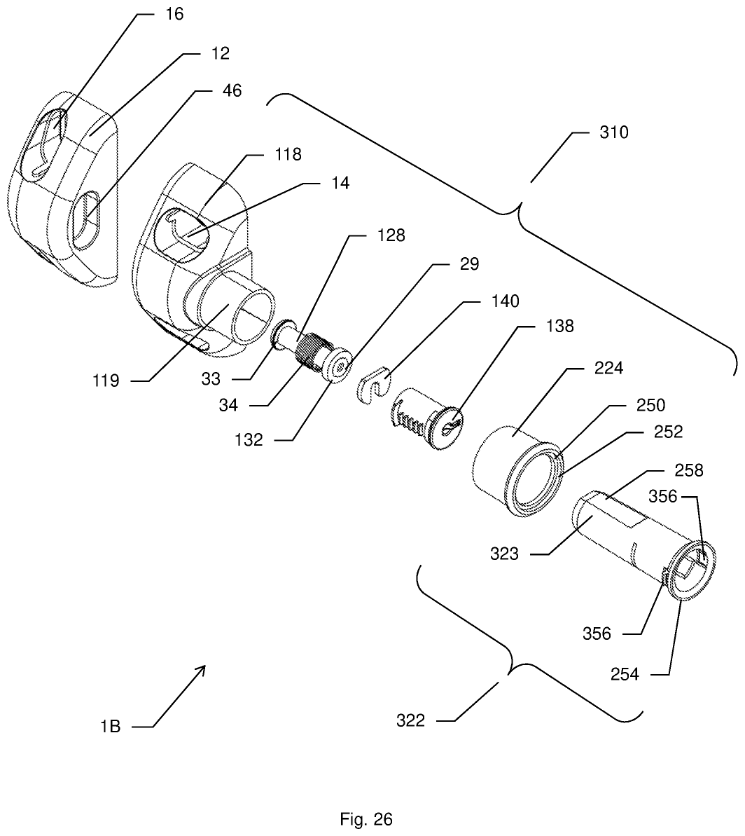

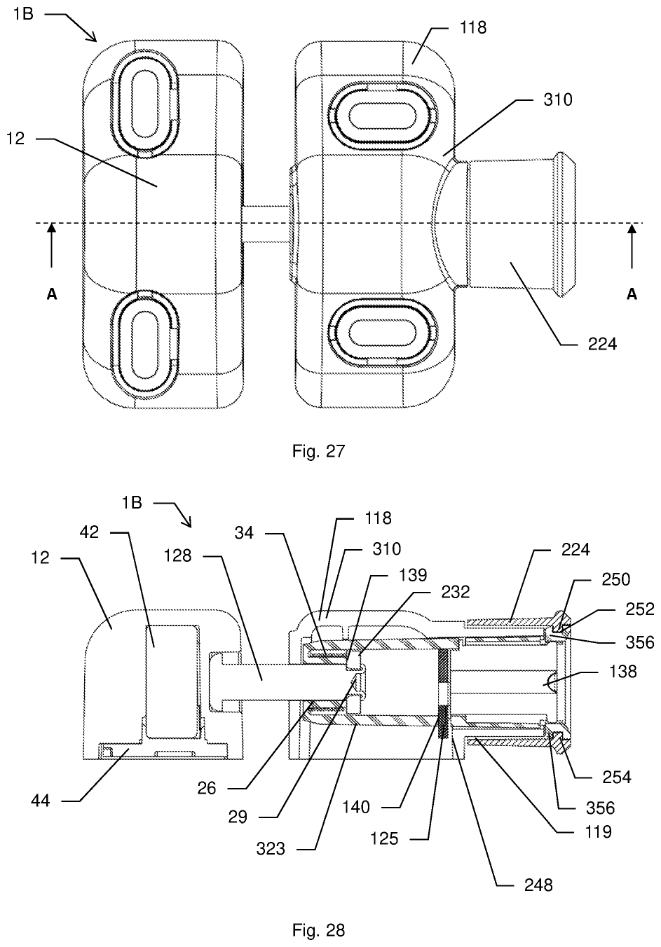

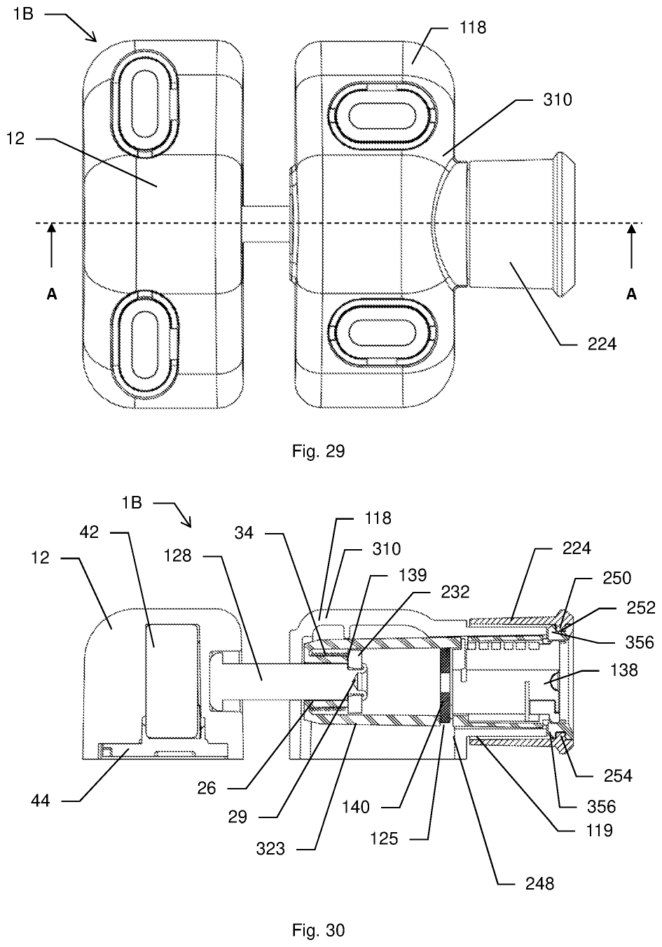

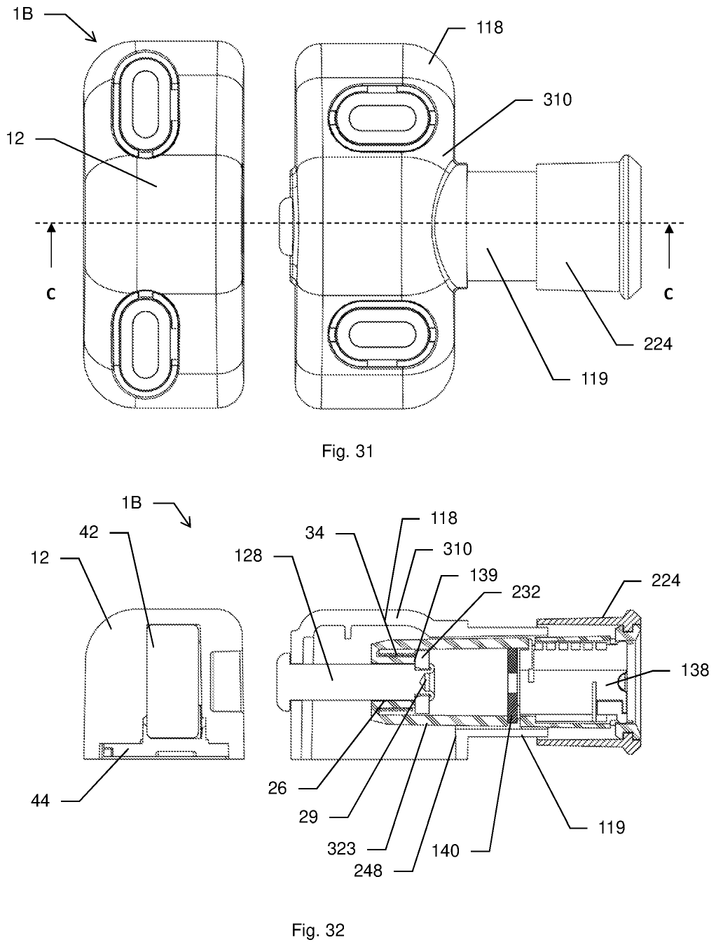

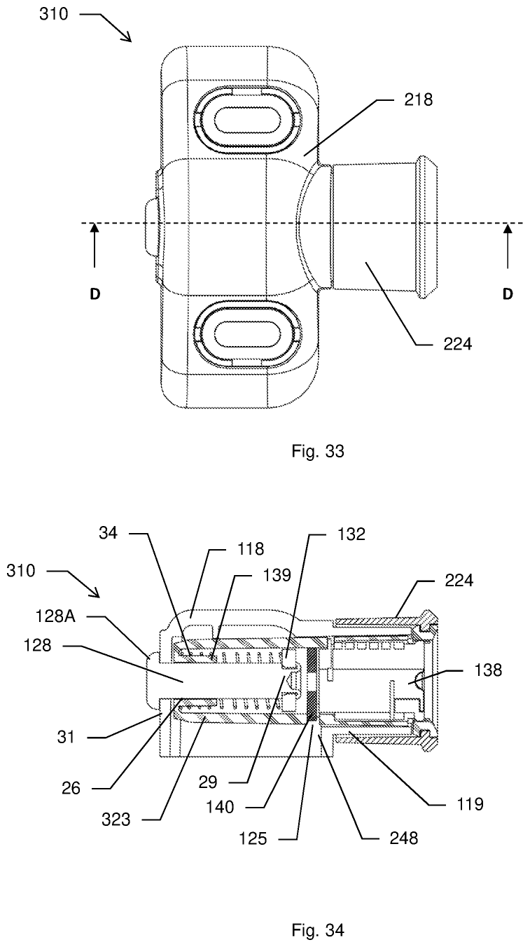

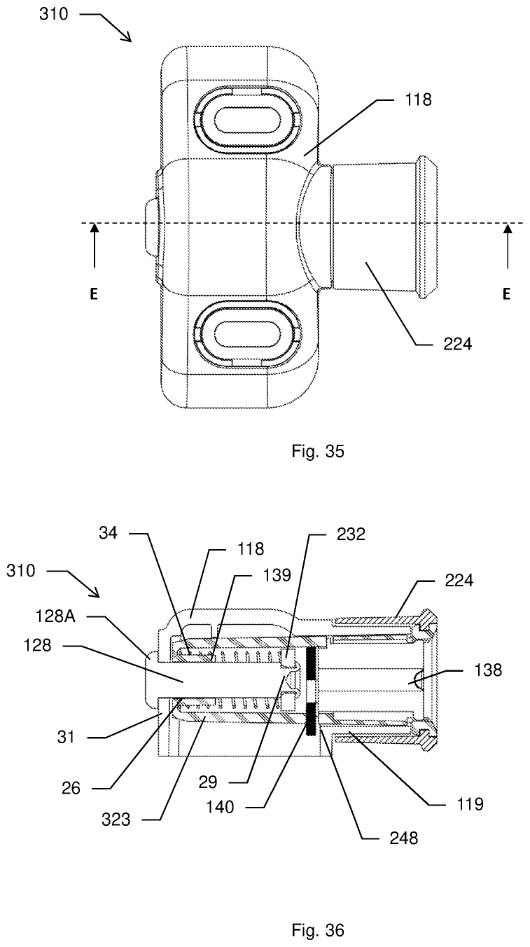

FIGS. 12 to 35 illustrate two embodiments of the latch assembly according to the present disclosure. Referring now to a first embodiment of the latch assembly shown in FIGS. 12 to 24. Like parts are given like reference numerals for like features. The primary difference between the prior art magnetic latch assembly 1 and the first embodiment of the latch assembly 1A is that the retractable actuator 222 and the retraction knob 224 are formed as two separate components. The knob may be formed separate to the elongate body and mounted thereon via a mounting arrangement.

The latch assembly 1A comprises a latching unit 210 with a displaceable latch pin 128, and a retractable actuator 222 formed separate to the latch pin 128 and mounted in the latching unit 210, the retractable actuator 222 being moveable along a latch axis to move the latch pin 128 towards a retracted position to enable the moveable barrier to be moveable from the closed position, wherein the retractable actuator 222 including an elongate body 223 extending between opposing ends, and a knob 224 being formed separate to the elongate body 223 and mounted thereon via a mounting arrangement.

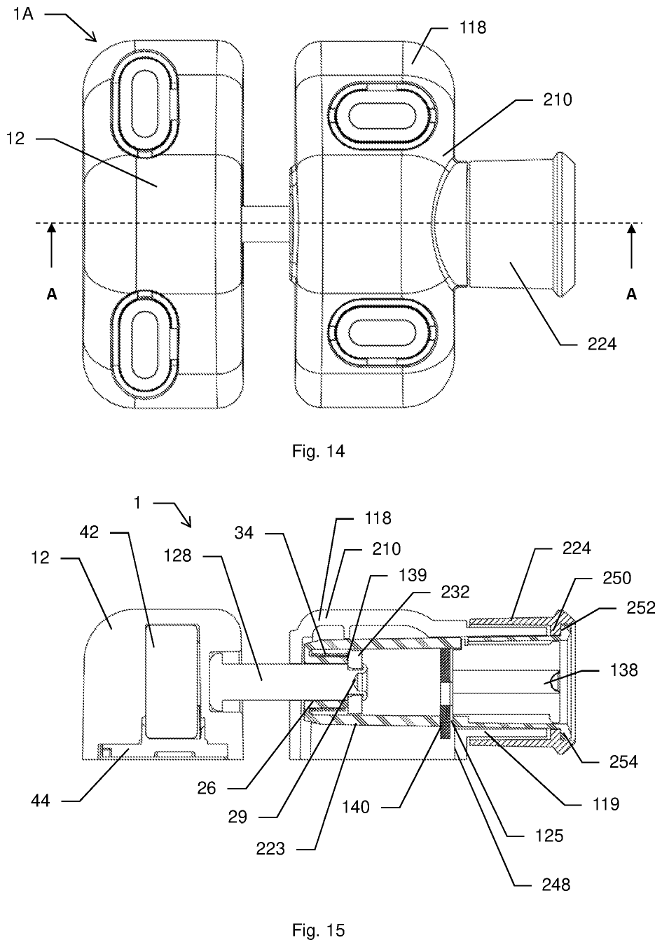

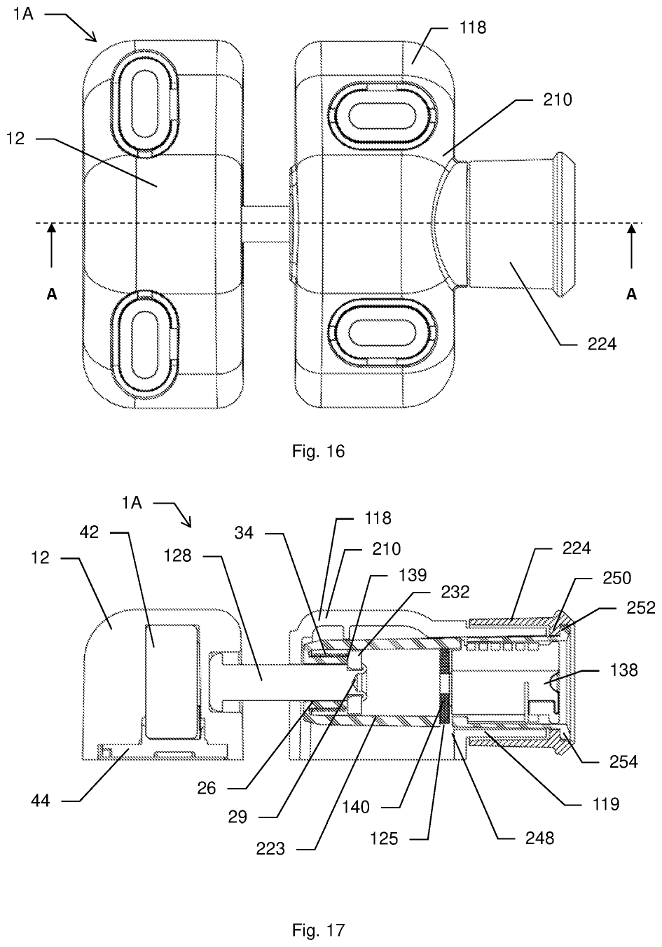

FIGS. 14 and 15 show a configuration of the latch assembly 1A when the lock 138 is locked and the latching unit 210 is in the latched position. In the locked condition, an aperture 125 is aligned with an internal wall 248 of the housing 118 for receiving a locking tongue 140. As shown, the knob 224 cannot be operated as the locking tongue 140 abuts the internal wall 248. FIGS. 16 and 17 show a configuration of the latch assembly 1A when the lock 138 is unlocked and the latching unit 210 is in the latched position. As shown, the latch pin 128 is magnetically attracted towards a high coercivity magnet 42 in the receiver unit 12 in the latched condition.

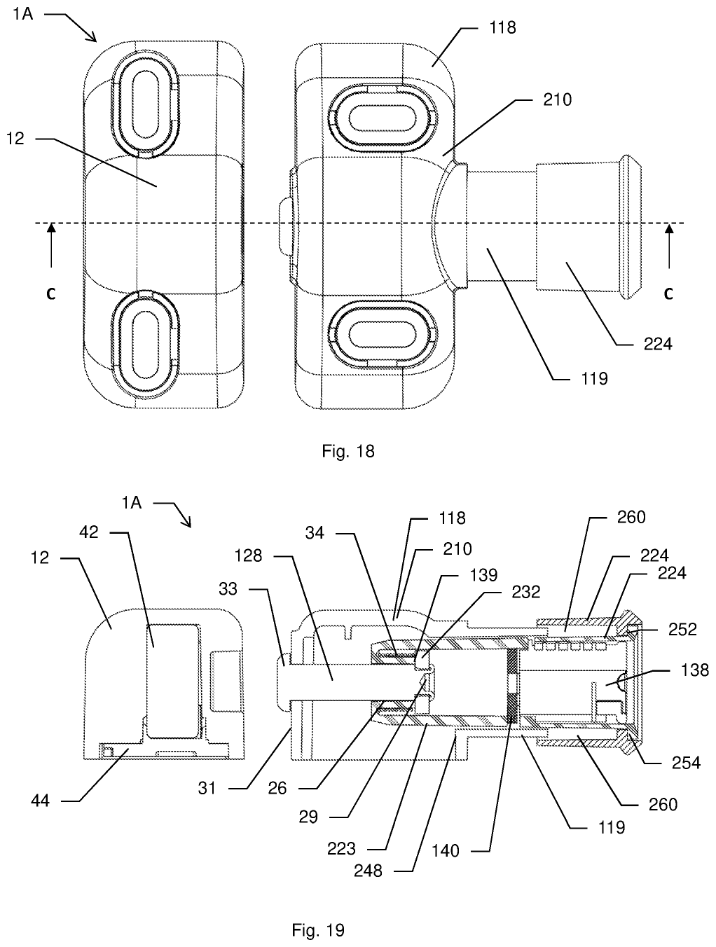

FIGS. 18 and 19 show a configuration of the latch assembly 1A when the lock 138 is unlocked and the latching unit 210 is in the unlatched position, wherein retractable actuator 222 including an elongate body 223 the knob 224 is pulled to the right.

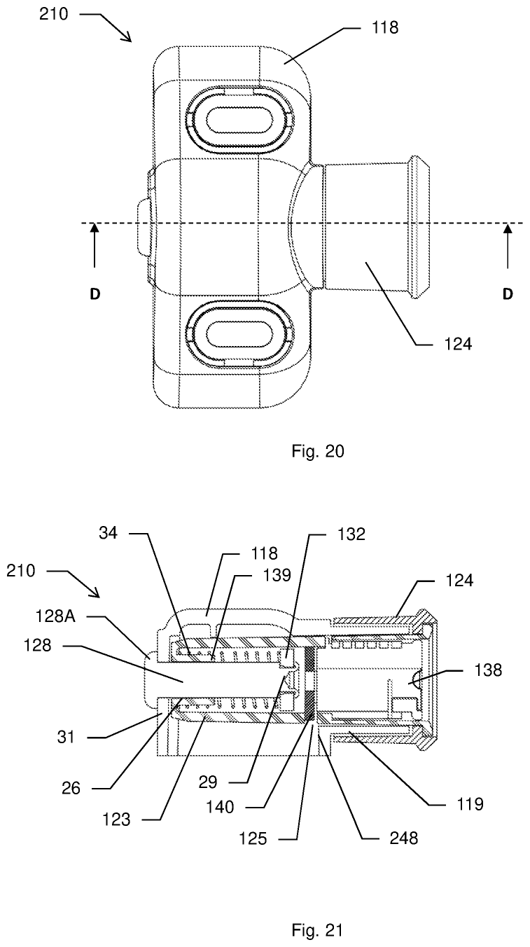

FIGS. 20 and 21 show a configuration of the latching unit 210 when the lock 138 is unlocked and the knob 224 is released or retracted. This simulates when a gate is opened and the latching unit 210 is remote from the receiver unit 12.

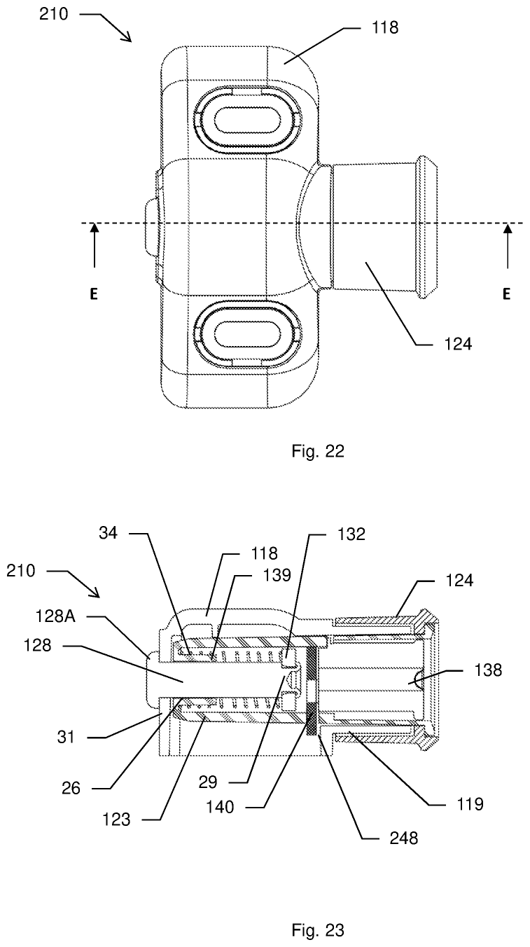

FIGS. 22 and 23 show a configuration of the latching unit 210 when the lock 138 is locked and the knob 224 is released or retracted, yet the latch pin 128 is free to move axially.

As shown in the Figures, the retractable actuator 222 is formed separate to the latch pin 128 and includes the elongate body in 223 the form of a slideable barrel. The elongate body 223 extends between opposing first and second ends. The first end extends external the latching unit 210 and the second end is housed internal the latching unit 210. The retraction knob 224 is mounted to the first end of elongate body 223 via the mounting arrangement. An annular recess 260 is provided between the retraction knob 224 and the elongate body 223 into which the tubular extension 119 of the housing 118 slidingly fits.

The mounting arrangement comprises one or more complementary key surfaces formed on an internal wall of the knob 224 and the external wall of the elongate body to allow rotation of the knob 224 about the elongate body 223 and prevent axial movement of the knob 224 relative to the elongate body 223. As shown for example in FIG. 15, the internal wall of the knob 224 includes at least one flange 250. In the illustrated embodiment, the knob 224 includes one flange extending radially from the external wall of the elongate body. The flange 250 is also annular such that it extends about the internal circumference of the wall of the knob 224. Adjacent the flange 250, defined is an internal annular recess 252 disposed at the end of the knob 224.

Likewise, the elongate body 223 of the actuator 222 defines a complementary recess towards the first end of the elongate body 223 for mating with the flange 1050 of the knob 224. At the first end of the elongate body 223, the actuator includes a projection 254, in the form of a second flange, extending radially from the external wall of the elongate body 223. Adjacent the recess 252, toward the first end of the elongate body 223, the projection 254 is provided to mate with or reside in the annular recess 252 positioned on the inner diameter of the knob 224. In this way, the mounting arrangement engages the knob 224 on the elongate body 223 to prevent movement of the knob 224 in the direction of the latch axis. An end of the knob 224 is aligned with the first end of the elongate body 223. In the illustrated embodiment, the mounting arrangement prevents removal of the knob 224 from the elongate body 223 in the direction of the latch axis.

As shown, the latch assembly further comprises a retaining structure (not shown) to prevent rotation of the elongate body 223 about the latch assembly axis relative to the housing 118. The housing 118 includes an internal wall defining a passage for receiving the elongate body 223, and in particular, for receiving the second end of the elongate body 223. The retaining structure includes one or more complementary key surfaces. The elongate body 223 includes one or more key surfaces in the form of one or more faces 258. The face 258 extends from the second end towards the first end and is a non-cylindrical surface, e.g., a planar surface, which intersects the cylindrical shape of the external wall. The internal wall of the passage includes one or more complementary key surfaces (not shown) to mate with the one or more key surfaces of the elongate body 223, e.g., the face 258, to assist in the assembly of the latching unit 210. The face 258 provides a guide for the correct orientation and insertion of the elongate body 223 into the housing 118 during the assembly process. In the addition, the face 258 prevents rotation of the elongate body 223 relative to the housing 118. A small clearance is provided between the complimentary key surfaces (not shown) to allow the elongate body 223 to move axially with respect to the housing 118 with minimal friction, but also restricts rotational movement between the elongate body 223 and the housing 118.

As discussed above, the mounting arrangement comprises the flange 250 provided on the inner diameter of the retraction knob 224, which forms an annular recess 252 for receiving the flange 254 disposed on the outer diameter on the first end of the elongate body 223. As shown in the Figures, the flanges 250, 252 may extend circumferentially on the retraction knob 224 and/or on the elongate body 223. As shown in the FIGS. 18 and 19 when the lock 138 is unlocked and the locking tongue 140 is displaced, the knob 224 can then be pulled to the right to the unlatched condition. When the knob 224 is pulled, the flange 250 of the knob 224 abuts the flange 252 of the elongate body 223, thus allowing the elongate body 223 to move with the knob 224. When compared to FIGS. 16 and 17, pulling of the retraction knob 224 causes a spring 34 to be compressed and the peripheral portion of a washer 232 engages against a shoulder 139 in the intermediate portion of the elongate body 223 and allowing the latching pin 128 to be retracted. Further pulling movement of the knob 224 is limited by an enlarged tip/head 128 of the latching pin 128 abuts the end face 31 of the housing 118.

As shown in FIGS. 14 to 17, the latching pin 128 of the magnetic latch 1A is magnetically attracted towards the high coercivity magnet 42 in the receiver unit 12. When the elongate body 223 is retracted, the second end of the elongate body 223 abuts the internal of an end face 31 of the housing 118 and this is caused by the spring 34 being biased between the elongate body 223 and a washer 232. The washer 232 is fitted to a circular cross-section spigot portion 29 of the latch pin 128, and the washer 1132 fulfils a similar function to the cap 32 of the prior art magnetic latch assembly. Retraction of the elongate body 223 also causes the knob 224 to move in the same direction as the flange 254 of the elongate body 223 abuts the flange 250 of the knob 224 and driving the knob 224 to retract.

As shown in FIGS. 15, 17, 19, 21 and 23, there are small clearances between the knob 224 and the elongate body 223 and, and between the knob 224 and the tubular extension 119. These small clearances allow the knob 224 to free-wheel or freely rotate with respect to the housing 118 and the elongate body 223, while still allowing the knob 224 to pull the elongate body 223 to the unlatched condition.

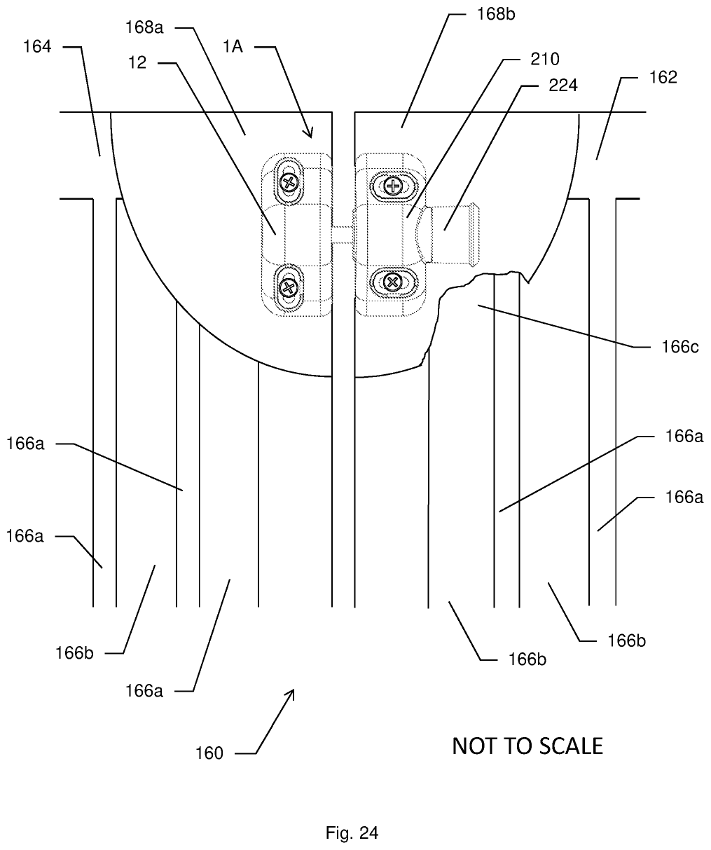

One main advantage of the allowing the knob 224 to rotate, e.g., free-wheel or freely rotate, with respect to the housing 118 and the retractable actuator 222 is to increase the difficulty of the operating the knob 224 being operated by young children when the latching unit 210 is in the unlocked condition, which will be described in more detail below with reference to an embodiment of the latch assembly of FIGS. 12 to 23 installed on an embodiment of a fencing arrangement illustrated in FIG. 24. The torque that can be applied from the knob to the elongate body is limited.

FIG. 24 illustrates a fencing arrangement 160 in its closed configuration comprising a movable barrier 162, e.g. a gate, a fence 164 and the magnetic latch assembly 1A. For illustrative purposes, the safety fencing arrangement 160 of FIG. 24 is not shown to scale.

As shown in the FIG. 24, the movable barrier 162 and fence 164 is a picket style barrier comprising a series of adjacent vertical slats 166a separated by apertures 166b. As shown, the latching unit 210 is mounted to the movable barrier 162 by screws and the receiver unit 12 is mounted to the fence 164 by screws. In order to meet local safety gate legislations, shielding 168a, 168b are provided to prevent young children accessing the knob 224 via the apertures 166b to unlatch the magnetic latch assembly 1A positioned on the other side of the movable barrier 162 or fence 164. As illustrated in FIG. 24, a portion of the shielding 166b used for shielding the latching unit 210 is damaged with an enlarged and exposed aperture 166c is adjacent to the knob 244 allowing access for young children to operate the knob 224. Because young children have limited dexterity, whilst they may be able reach the knob 224 via aperture 166c, they may not be able to operate/pull the knob 224 as the knob 224 is able to rotate about the elongate body 223 and this increases the level of difficulty for young children to pull the knob 224.

In addition, legislative requirements on child safety barriers differ from country to country and even differs between states, for example, the dimensions and the area of protection for the shielding of self-latching devices can vary. The knob 224 being able to rotate, e.g., free-wheel, with respective to the elongate body 223 as means to further enhance safety.

As shown in FIGS. 12 to 24, the end face of the elongate body 223 is recessed into the knob 224 to prevent any user gaining a hold of the elongate body 223. In addition, as shown in FIG. 12, the recessed end face of elongate body 223 also allows the face of the lock 138 to be recessed and provide further protection of the lock 138 from weathering and external elements.

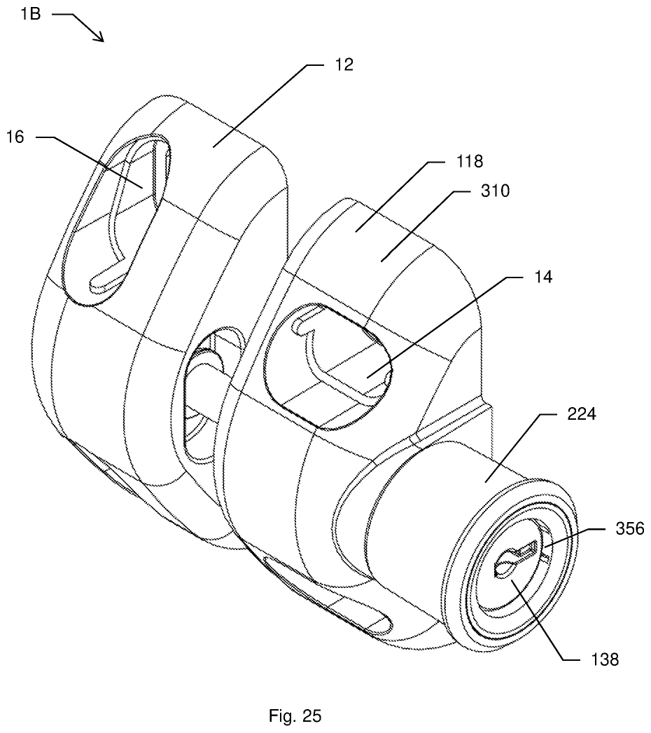

FIGS. 25 to 36 illustrate the second embodiment of the present disclosure. Like parts have been given like reference numerals but may not be further described, and where a component is equivalent, the reference numeral shall begin with 3; for example, the elongate body 123, 223 becomes elongate body 323 as shown in FIG. 25. Likewise, the views to illustrate the second embodiment on FIGS. 25 to 36 are given like views that illustrate the first embodiment on FIGS. 12 to 23, and where necessary only the material differences between the first and second embodiment shall be described. The primary difference between the first embodiment of the latching unit 210 and a latching unit 310 of the second embodiment is the mounting arrangement of the knob 224 to the elongate body 323 is the retaining structure including a series of snap features 356 is provided on the elongate body 323. In the illustrated embodiment, the retaining structure allows rotation of the knob about the elongate body and prevents axial movement of the knob relative to the elongate body.

When the actuator 322 is assembled, i.e. the knob 224 is mounted to the elongate body 332, snap features 356 engage with the flange 250 of the retraction knob 224. A clearance is provided between the snap features 356 and the flange 250 to allow rotation of the knob 224 about the elongate body 323. However, the additional benefit of the snap features 356 to prevent axial movement of the knob 224 relative to the elongate body 323. In other words, the series of snap features 356 maintain an axial relationship between the elongate body 323 and the knob 224 and preventing axial separation between the elongate body 323 and the knob 224.

In the illustrated embodiment, the one or more snap features 356 are in the form of snap members spaced apart about the circumference of the external wall of the elongate body 323. In the illustrated embodiment, the snap members 356 are equally spaced apart about the elongate body 323 and include two snap members 356 that are in opposing relation. The snap members 356 are positioned towards the first end of the elongate body 323 adjacent the flange 254.

As shown in FIGS. 25 to 36, the latching unit 310 of the second embodiment maintains the identical function of the latching unit 210 of the first embodiment as described above.

In alternative non-illustrated embodiments, one or more snap features may be alternatively provided on the knob for engaging with the flange of the elongate body. This also can maintain axial relationship between the elongate body and the knob.

Although FIG. 25 shows two snap features 356 provided on the elongate body 323, three snap features 356 may be provided on the elongate body 323 to allow the retraction knob 224 to self-centralise or maintain concentricity with the elongate body 323. Further, it is understood that any number of snap features or snap-fit variations may be provided.

In addition to enhancing safety, the present assignees consider there is an opportunity of providing a more reliable key-to-latch visual pairing, for example, a portion of the latching unit can be colour coded with a key tag associated with a specific key cut profile. This may be useful for complex managers where different keys are used for different latching units to restrict or control access to certain areas.

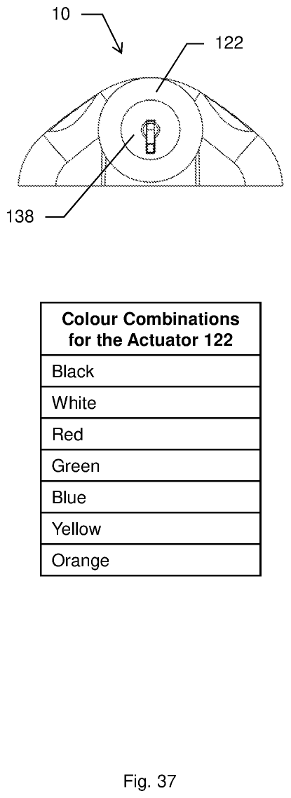

FIG. 37 shows a side view of the prior art latching unit 10, whereby the retractable actuator 122 can be moulded in seven different colours. This allows up to seven key-to-latching unit combinations.

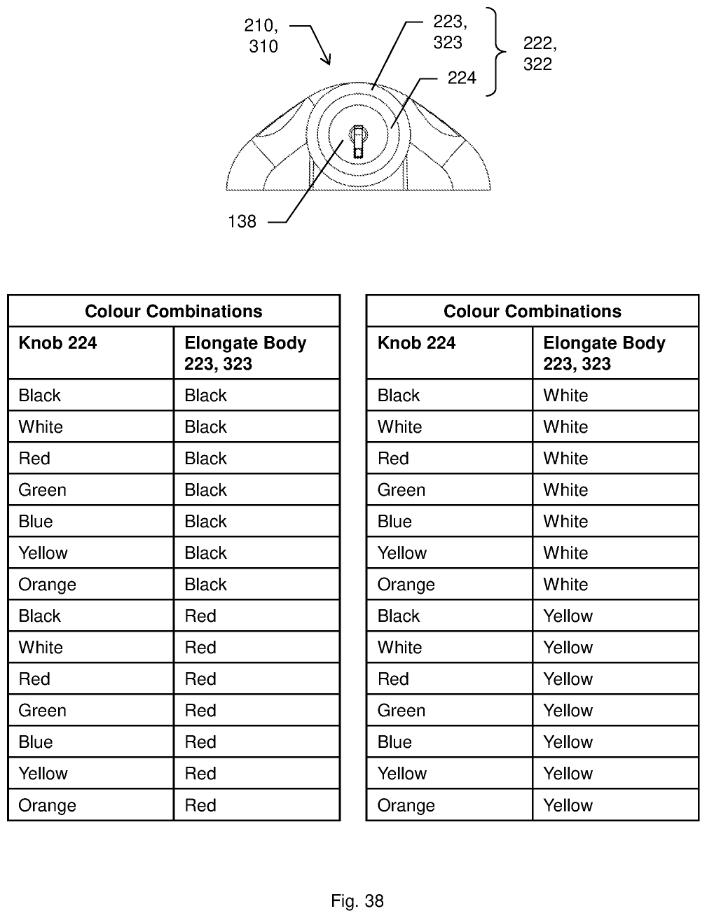

FIG. 38 shows a side view of the latching unit 210, 310, whereby the elongate body 223, 323 and the knob 224 can be moulded in seven different colours. However, there can be multiple colour combinations for the elongate body 223, 323 and the knob 224 that allow multiple key-to-latching unit combinations and further increasing security.

Since the elongate body 223, 323 and the knob 224 are moulded as separate components in comparison to the unitary actuator 122 of the prior art, there could be efficiency gains when these components are moulded from engineered polymers. For example, the run time for moulding the unitary actuator 122 of the prior art is 30 secs, whereas the run time for moulding elongate body 223, 323 and the knob 224 in a family tool is 20 secs. Therefore, there could be efficiency gains if the manufacturing schedule recommends moulding components in high quantities.

In some embodiments, the mounting arrangement may be releasable to allow removal and replacement of the knob on the elongate actuator. For example, the latch assembly can be a modular latch assembly wherein the knob forms part of a series of knobs with different characteristics. Each of the different types of knobs can be installed on the elongate actuator to adapt the characteristic of the latch assembly. The knob may form part of a series of knobs with different characteristics each of which can be installed on the elongate actuator to adapt the characteristic of the latch assembly. For example, the knob may be different sizes, colours, or include a texture surface finish to facilitate gripping. In this way, the latch assembly has design flexibility.

As described above with reference to FIGS. 1 to 3, the receiver unit 12 comprises the elongated slots 16 for receiving screws (not shown) to allow the receiver unit 12 to be mounted to a structure or mounting brackets from the front. In use, press-in cover elements (not shown) will be provided for closing the apertures leading to the slots 16. As shown, the magnet 42 is located in a weather-sealed cavity by engagement of a back plate 44.

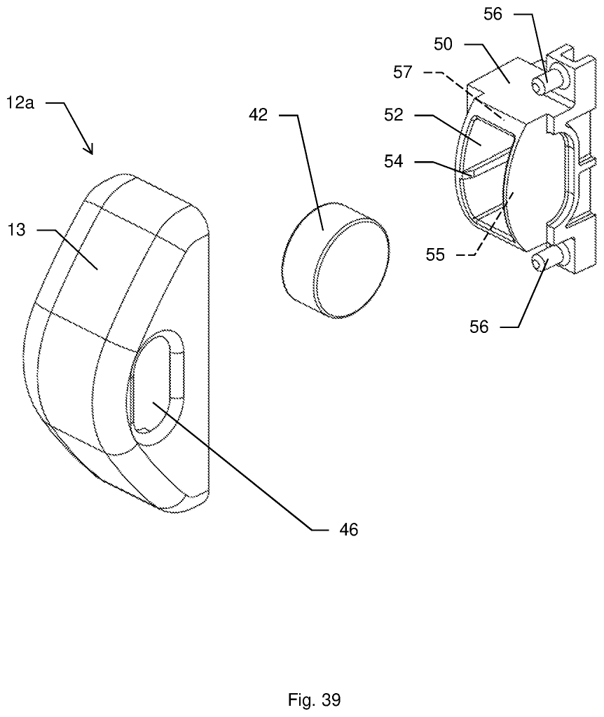

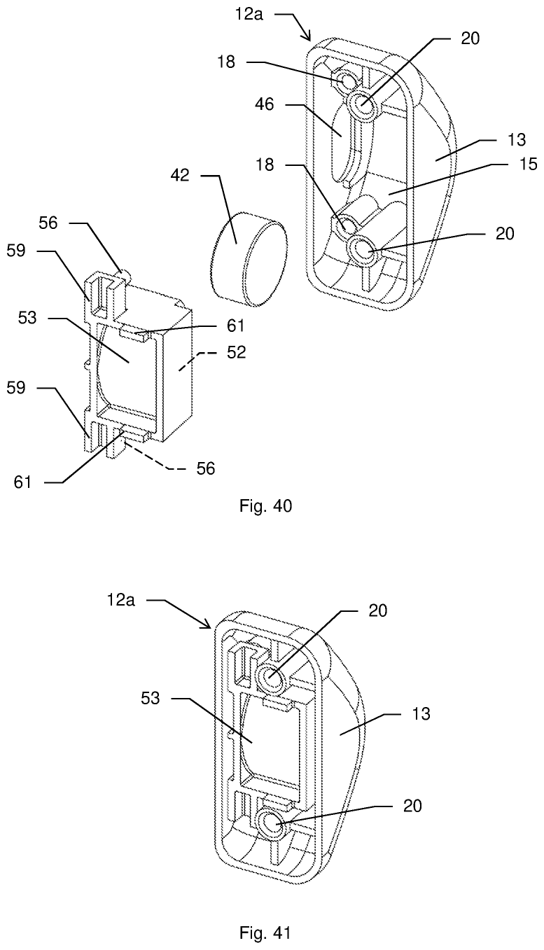

FIGS. 39 to 43 illustrate a further embodiment of the receiver unit 12a, whereby the receiver unit 12a can be mounted to a structure or mounting brackets from a rear of the receiving unit 12a. FIG. 39 is an exploded front isometric view of the receiver unit 12a. FIG. 40 is an exploded rear perspective view of the receiver unit 12a, and FIG. 41 is a rear perspective view of the receiver unit 12a when assembled.

As shown, the receiver unit 12a comprises a receiver body 13 and a carrier 50. The receiver body 13 has an interior surface defining a cavity 15 opening at a rear of the receiving body 13 for receiving a carrier or cradle 50 therein. The receiver body 13 also includes a latching cavity 46 for receiving the latching pin 128. As shown, the latching cavity 46 comprises an aperture provided in the receiver body 13 and said aperture is closed off by the carrier 50. In this way, the latching cavity 46 is a combination of the aperture provided in the receiver body 13 and the aperture being closed off by the carrier 50.

The carrier 50 comprises at least one internal wall defining a magnet cavity 52 for receiving the magnet 42. The magnet is arranged within the cavity so as to magnetically attract the latch pin towards a displaced position, i.e. to move the latch pin into the latching cavity 46 so as to secure the moveable barrier in a closed position.

In the form shown in FIGS. 39 to 43, the internal walls of the cavity include two internal side walls 55, two end walls 57 and a rear wall 53. The two internal sidewalls include a front wall 55. The front wall 55 is configured to space the magnet from the latch pin when the latch pin is in the displaced position.

The front wall 55 has two opposing faces: a first of the two opposing faces, i.e. a latching face, is configured to contact the latching pin 128 when the latching pin 128 is in a displaced position. A second of the two opposing faces defines a part of the cavity 52, i.e. one of the four inwardly facing surfaces of the cavity.

The internal walls are configured for receiving at least a portion of the magnet. In the form shown in FIGS. 39 to 43, for example, the internal walls can be sized to receive the entirety of the magnet, i.e. the whole of the magnet, such that the magnet is substantially encased by the carrier. In some alternative forms, the internal walls can be configured to extend part-way across a side of the magnet such that only a portion of the magnet is encased by the carrier, and another portion of the magnet extends out from the carrier.

One or more retention portions, e.g., ribs or protrusions 54 may be provided on the internal walls of the cavity 52 to ensure friction or interference fit between the magnet 42 and the internal walls of the cavity 52. In the form shown in FIG. 39, the retention portions 54 extend from an opening of the magnet cavity along each side wall 55 to the rear wall 53. This allows the magnet to be releasably retained in the carrier. In some forms, at least one of the ribs 54 extends at least a part way along a length of the side walls. For example, an end of the ribs (i.e. one or more of the ribs) can be offset from the opening such that the rib only extends half-way along the length of the sidewalls. In this way, a portion of the walls 55 proximal to the opening of the magnet cavity would not have any rib portions.

In some forms, not shown, a rib can be arranged on only one wall, e.g. the front wall 55, whereby an opposing sidewall does not have a rib. In this form, the rib on the front wall can be sized to extend from the face of the wall such that when a magnet is placed in the cavity, the rib and the opposing sidewall apply the interference fit to the magnet.

In some forms, the ribs can be tapered so as to provide a wider opening in the cavity (i.e. a wider distance between opposing ribs) for receiving the magnet. The taper of the ribs can be configured such that a transition surface, i.e., the portion of the rib configured to taper, extends at an angle between the side wall and the rib. In this way, the rib tapers towards the rear wall such that at least a portion of the rib 54 proximal to the rear wall 53 engages with at least a portion of the magnet 42.

Advantageously, the tapered rib increases the ease of which the magnet can be inserted into the cavity 52 by providing a clearance fit, i.e. a loose fit, at the opening, that can guide the magnet into the cavity. As the magnet is inserted further into the cavity, the rib tapers (via the transition surface) to an interference fit whereby the space between opposing ribs 54 is dimensionally smaller than a width of the magnet.

The advantage of having friction or interference fit between the magnet 42 and the cavity 52 is to prevent the magnet 42 from vibrating and causing unwanted noise when the movable barrier is being closed or latched.

The opening of the cavity 52 is defined by an edge region of the side walls 55 and the end walls 57. The edge region of the side walls 55 and end walls 57 are arcuate when viewed in profile (i.e., a side view), so as to correspond in shape with the interior surface, i.e. cavity 15 of the receiver body 13. In some forms, the edge region can be alternatively shaped, e.g. square-shaped, to correspond with e.g. a square-shaped cavity 15. Alternatively, the shape of the edge region may be differently shaped to the shape of the cavity. For example, the edge region can be square-shaped, and the cavity may be arcuate in shape.

In the form shown in FIGS. 39 to 43, the magnet is cylindrical in shape or a rounded flat shape. In this form, the cavity 52 is shaped to correspond with the (cylindrical) shape of the magnet 42. It is envisaged that alternatively shaped magnets can be utilised in the receiver unit, e.g. square, whereby the shape and dimensions of the cavity 52 are correspondingly shaped. In some forms not shown, the cavity is shaped differently to the magnet, i.e. the shape of the magnet 42 is e.g., square and does not correspond with the e.g. arcuate shape of the cavity 52.

As best shown in FIGS. 40 and 41, the rear wall 53 is shaped to correspond with a shape of the magnet 42. The rear wall 53 is an arcuate shape, i.e. semi-circular when viewed in profile, to correspond with the shape of the cylindrically-shaped magnet.

In a further embodiment, the receiver body 13 can be cast from a metallic material and the carrier 50 can be moulded from a polymer material. Advantageously, the carrier 50 prevents direct contact between the magnet 42 and the metallic receiver body 13 and further prevents vibration between the magnet 42 and the metallic receiver body 13.

As best shown in FIG. 40, the carrier 50 comprises two protrusions 56 for mating, e.g., releasably connecting with respective carrier-mounting bosses 18 provided in the cavity 15 of the receiver body 13. During assembly, the magnet 42 is first inserted into the cavity 52 of the carrier 50, and then the carrier 50 and the magnet 42 are inserted together into the cavity 15 of the receiver body 13. FIG. 41 shows the assembled receiver unit 12a, whereby the carrier 50 with the magnet 42 is inserted into the cavity 15 of the receiver body 13.

The advantage of using the carrier 50 for securing the magnet 42 is to allow better control or accurate axial alignment between the axial line of the magnet 42 and the latching cavity 46. This ensures the reliable latching between the latching pin 128 with the latching cavity 46 and the magnet 42.

Referring to FIG. 41, the receiver body 13 further comprises structure-mounting bosses configured to releasably connect the receiver unit 12a to the structure. That is, the structure-mounting bosses connect the assembled receiver body 13 and carrier 50 together onto the structure.

The carrier-mounting bosses and the structure-mounting bosses extend from the cavity 52 towards the opening at the rear of the receiver body 13. As shown, the carrier 50 is routed around two structure-mounting bosses 20 provided on the receiver body 13 to ensure the two structure-mounting bosses 20 are accessible after assembly. In other words, the carrier-mounting bosses 18 and the respective and correspondingly shaped protrusions 56 of the carrier 50 are arranged with respect to the support-mounting bosses 20 such that when the carrier 50 is received in the cavity 15 of the receiver body 13, the structure-mounting bosses 20 are still accessible at the rear of the receiver body for mounting the receiver unit 12a to the structure.

In the form shown in FIGS. 40 and 41, the carrier 50 is generally ‘T-shaped’, when viewed from the rear wall of the carrier, such that when received, i.e. nested, within the cavity 15, the protrusions 54 and magnet cavity 52 (i.e. side, end and rear walls, 55, 57, 53) of the carrier locate around the structure-mounting bosses 20.

The carrier 50 is further shaped such that, when the carrier is assembled within the cavity 15 of the receiver body 13, a rear side (or underside), i.e. a side of the carrier proximal to the rear wall 53, is located generally flush with the opening of the cavity 15. This is best shown in FIG. 41. The generally flush arrangement allows the receiving body to be substantially contained within the receiver body 13 so that when the unit 12a is mounted to the structure, the rear side of the carrier and the opening of the body 13 both contact the structure.

The carrier is supported in the generally flush position by the carrier-mounting bosses 18. The carrier-mounting bosses extend from the cavity 15 such that an end of the bosses 18 is spaced, i.e. inwardly offset, from the opening of the cavity 15 to receive a portion 59 of the carrier 50. In the form shown, the portions of the carrier 50 take a dog-leg like form 59, extending from an external surface of the end walls 57 to connect with, i.e. support, the protrusions 56.

When the carrier 50 is received in the cavity 15, the dog-leg portions 59 of the carrier 50 locate on, i.e. contact with, the ends of the carrier-mounting bosses 18 to position the rear side of the carrier 50 flush, i.e. level with the opening of the cavity 15.

The structure-mounting bosses 20 are configured to extend from the cavity 15 such that ends of the bosses 20 are flush with the opening of the cavity 15. As such, when the carrier 50 is assembled with the receiver body 13, the ends of the structure-mounting bosses 20 and the rear side of the carrier 50 are both flush with the opening of the cavity 15 of the receiver body 13.

Each of the carrier- and structure-mounting bosses 18, 20, can be structurally supported by internal flanges connecting between the bosses and the receiver body 13.

Advantageously, each structure-mounting boss 20 is configured to receive a threaded fastener, i.e. each boss 20 comprises an internal helical thread or features for receiving screws, bolts or the like. During installation of the receiver unit 12a, the two structure-mounting bosses 20 allow the receiver unit 12a to be mounted to a structure or mounting brackets from the rear of the unit, i.e. mounted about the rear opening of the receiver body 13.

This arrangement allows the receiver unit 12a to be mounted to the structure.

The advantage of having the receiver unit 12a that can be mounted to a structure or mounting brackets from the rear is to eliminate the need for press-in cover elements (not shown) that are needed in with the receiver unit 12 with elongated slots 16 on the front for front mounted installation.

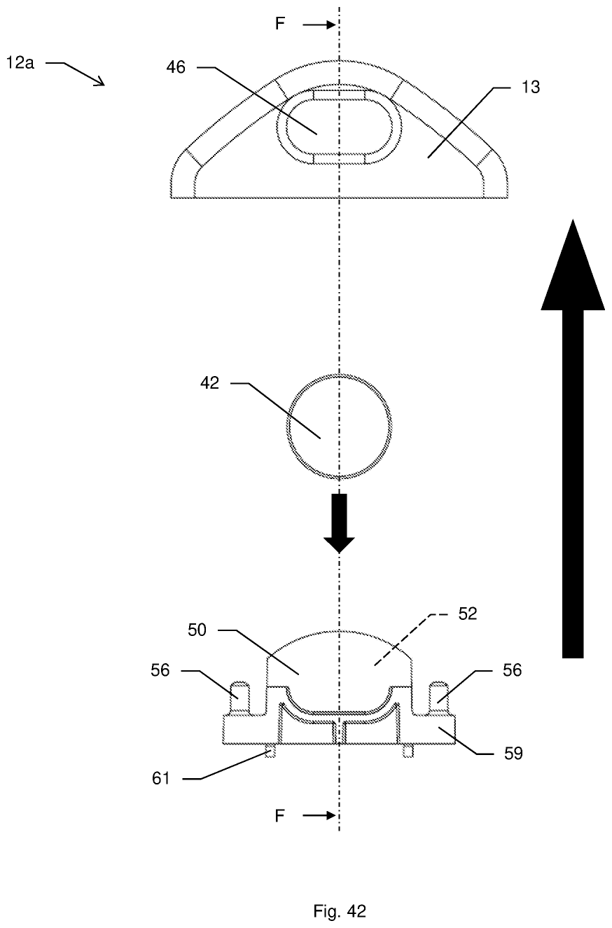

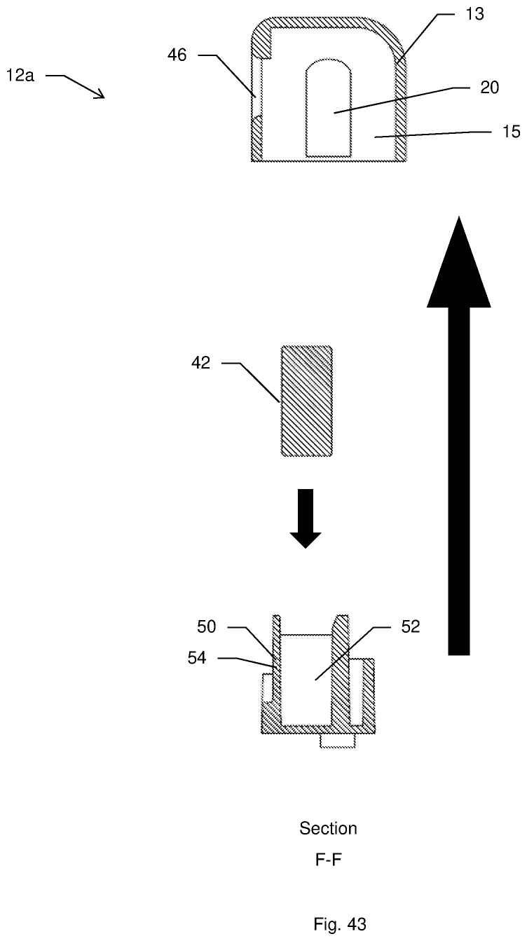

FIG. 42 shows an exploded front view of the receiver unit 12a and FIG. 43 is a cross section view through line F-F of FIG. 42. As shown in FIG. 43, the latching cavity 46 opens into the cavity 15 of the receiver body 13 and the front wall 55 of the carrier 50 is positioned with respect to the latching cavity so as to form the latching face for the latching pin 128 (not shown). It can be envisaged when the receiver unit 12a is assembled, the front wall 55 separates the latching cavity 46 from the cavity 15 of the receiver body 13, such that the latching pin 128 (not shown) would engage the latching face of the front wall 55 via the magnet 42. It can be envisaged the latching cavity 46 would limit the lateral movement of the latching pin 128 (not shown) to maintain the latching unit in a latching condition.

As best shown in FIG. 42, the latching cavity 46 can be obround-shaped. The obround-shape has a length (e.g. in an in-use vertical orientation of the receiving unit 12a) which is greater than its width (e.g. in an in-use horizontal orientation of the receiving unit 12a). Advantageously, the length of the obround-shaped latching cavity 46 can accommodate vertical misalignment between the latch pin 128 and the latching cavity 46. For example, if the latching unit is mounted higher, or lower, than the corresponding receiving unit 12a, the obround-shaped latching cavity 46 can provide a larger opening (i.e. vertical length) for receiving the latch pin 128.

Furthermore, the obround-shaped latching cavity 46 can limit lateral movement between the latch pin 128 and the latching cavity 46.

As mentioned above, the carrier 50 can be moulded from a polymer material. A further advantage of the having the latching pin 128 (not shown) engaging the front wall 55 of the carrier 50 is to reduce the noise of the latching pin 128 (not shown) at the point of latching. That is, the polymeric material of the front wall 55 can absorb impact from the latching pin as the magnet pulls the latching pin into contact with the latching face.

Referring to FIG. 40, the carrier 50 can further comprise locating tabs 61 extending from the rear side of the carrier. The tabs can be utilised for alignment of the receiver unit 12a with respect to the structure when mounting thereat. As best shown in FIG. 42, the locating tabs 61 extend from the rear side of the carrier 50 such that when the carrier is received within the cavity 15 of the body 13, the tabs 61 protrude outwards from the rear side of the carrier. In this way, the tabs 61 are not flush with the ends of the bosses 20 or the opening of the cavity 15.

### Applications

Although the embodiments disclose the latch and system being used on gates, it can be envisaged that the latch and system can be used on other applications such as security fencing, zone restriction fencing, doors, safety barriers, security barriers, care homes, garden gates, swimming pool and child care applications etc.

### Alternative Embodiments

In the claims which follow and in the preceding disclosure, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the present disclosure.

Accordingly, the present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods which can, of course, vary. It is also to be understood that the terminology used herein is for the purpose of describing particular embodiments only, and is not intended to be limiting.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope being indicated by the following claims.

1-41. (canceled)

42. A latch assembly mountable to a structure for securing a moveable barrier in a closed position, the latch assembly comprising:
a latching unit with a displaceable latch pin; and
a retractable actuator mounted in a housing of the latching unit, the retractable actuator being moveable along a latch axis to move the latch pin towards a retracted position to enable the moveable barrier to be moveable from the closed position;
the retractable actuator including an elongate body extending between opposing ends, and a knob being formed separate to the elongate body and mounted thereon via a mounting arrangement.

43. A latch assembly according to claim 42, wherein the latch pin is formed separate to the retractable actuator, wherein the latching pin is coupled to the elongate body of the retractable actuator.

44. A latch assembly according to claim 42, wherein the mounting arrangement between the elongate body and the knob restricts the amount of torque that can be applied from knob to the elongate body.

45. A latch assembly according to claim 42, wherein the mounting arrangement allows the knob to freely rotate relative to the elongate body about the latch axis.

46. A latch assembly according to claim 42, wherein the mounting arrangement captures the knob on the elongate body to prevent axial movement of the knob on the elongate body in the direction of the latch axis.

47. A latch assembly according to claim 42, further comprising a retaining structure to prevent rotation of the elongate body about the latch axis relative to the housing of the latching unit.

48. A latch assembly according to claim 47, wherein the housing of the latching unit includes an internal wall defining a passage for receiving the elongate body of the actuator, and the retaining structure includes one or more complementary surfaces formed on the internal wall of the passage and an external surface of the elongate body to prevent rotation of the elongate body relative to the housing of the latching unit.

49. A latch assembly according to claim 42, wherein one of the ends of the elongate body having an aperture for receiving the latch pin and said latch pin is movably secured with respect said end of the elongate body.

50. A latch assembly according to claim 49, wherein a biasing means is provided between the latch pin and said of the elongate body, whereby the biasing means biases the latch pin towards the retracted position.

51. A latch assembly according to claim 42, wherein the mounting arrangement comprise one or more complementary features formed on an internal wall of the knob and the external wall of the elongate body to allow rotation of the knob about the elongate body and prevent axial movement of the knob relative to the elongate body.

52. A latch assembly according to claim 51, wherein the one or more complementary features comprise at least one projection extending radially on the external wall of the elongate body, and a complementary recess formed on the internal wall of the knob.

53. A latch assembly according to claim 51, wherein the one or more complementary features comprise at least one projection extending radially on the internal wall of the knob, and a complementary recess formed on the external wall of the elongate body.

54. A latch assembly according to claim 52, wherein the one or more complementary features of the mounting arrangement are positioned toward one of the ends of the elongate body so as to align an end of the knob with the end of the elongate body extending from the housing of the latching unit.

55. A latch assembly according to claim 42 further comprising a receiver unit having a magnet for attracting the latch pin towards a displaced position.

56. A latch assembly mountable to a structure for securing a moveable barrier in a closed position, the latch assembly comprising:
a latching unit with a displaceable latch pin; and
a receiver unit having a magnet for attracting the latch pin towards a displaced position and a carrier, the receiver unit including a receiver body including an interior surface defining a cavity for receiving the carrier therein, the carrier being configured for retaining the magnet;
wherein, the carrier includes at least one retention portion for releasably retaining the magnet in the carrier.

57. A latch assembly according to claim 56, wherein the carrier includes at least one internal wall defining a magnet cavity for receiving at least a portion of the magnet, the at least one internal wall having a latching face for spacing the magnet from the latch pin when the latch pin is in a displaced position.

58. A latch assembly according to claim 62, wherein the at least one retention portion is formed as at least one rib on the internal wall and extending into the magnet cavity.

59. A latch assembly according to claim 56, wherein the receiver body includes at least one structure-mounting boss configured to releasably connect the receiver body to the structure, whereby the at least one carrier-mounting boss and the at least one structure-mounting boss extend from the cavity towards an opening at a rear of the receiver body.

60. A latch assembly according to claim 56, wherein the receiver unit includes a latching cavity for receiving the latch pin.

61. A latch assembly according to claim 60, wherein the latching cavity is obround-shaped for accommodating vertical misalignment between the latch pin and the latching cavity.

62. A latch assembly according to claim 60, wherein the latching cavity is obround-shaped to limit lateral movement between the latch pin and the latching cavity.

63. A latch assembly according to claim 60, wherein the latching cavity is a combination of an aperture provided in the receiver body and said aperture being closed off by the carrier.
